(19) United States
(12) Patent Application Publication
(10) Pub. No.: US 2026/0332707 A1
(43) Pub. Date: Oct. 22, 2026

(54) DEVICE

(71) Applicant: SEIKO EPSON CORPORATION, TOKYO (JP)

(72) Inventor: Koji HARA, MATSUMOTO-SHI (JP)

(21) Appl. No.: 19/654,576

(22) Filed: Apr. 22, 2026

(30) Foreign Application Priority Data
Apr. 22, 2025 (JP) 2025-070298

(51) Int. Cl. H04N 1/00

(52) U.S. Cl. CPC H04N 1/00551; H04N 1/00352; H04N 1/00546; H04N 1/00559

(57) ABSTRACT

A device 10 includes a device main body 12 and an outer section 20. The outer section 20 is attached to an outside of the device main body 12 and constitutes an appearance of the device 10. The outer section 20 includes a first outer section 21 that constitutes an appearance of a continuous first region A1 and a second outer section 22 that constitutes an appearance of a continuous second region A2. The first outer section 21 contains a recycled resin material. The second outer section 22 does not contain the recycled resin material.

The present application is based on, and claims priority from JP Application Serial Number 2025-070298, filed Apr. 22, 2025, the disclosure of which is hereby incorporated by reference herein in its entirety.

### BACKGROUND

### 1. Technical Field

The present disclosure relates to a device that uses a recycled resin material.

### 2. Related Art

For example, JP-A-2016-156991 discloses an image forming device that forms an image on a medium as an example of an device. The image forming device includes a first image forming device to which a first outer cover (a 1A-th cover and a 2A-th cover) made of a non-recycled resin material is assembled, and a second image forming device to which a second outer cover (a 1B-th cover and a 2B-th cover) made of a recycled resin material is assembled. The first outer cover and the second outer cover have the same appearance shape. The first outer cover (the 1A-th cover and the 2A-th cover) and the second outer cover (the 1B-th cover and the 2B-th cover) have different internal appearance shapes so as not to be assembled in a wrong combination. Therefore, it is possible to prevent the occurrence of mounting errors of the first outer cover and the second outer cover having the same appearance shape between two types of image forming devices.

However, although JP-A-2016-156991 is directed to a device using an outer cover made of a non-recycled resin material and a device using an outer cover made of a recycled resin material, there is a case where it is desired to mix an outer cover made of a non-recycled resin material and an outer cover made of a recycled resin material in the same device. For example, there is a case where it is desired to increase the usage rate of a recycled material by changing an outer member such as an outer cover of a part of a device to a member made of a recycled resin material in consideration of the environment. For example, in a case where an outer member made of a non-recycled resin material and an outer member made of a recycled resin material are mixed, even outer members having the same color may have slightly different colors due to the difference between the non-recycled resin material and the recycled resin material.

As in the above-described example, when a member made of a non-recycled resin material and a member made of a recycled resin material are mixed in one device, various problems to be solved such as the impairment of an appearance of a device occur. Therefore, when a member made of a non-recycled resin material and a member made of a recycled resin material are mixed in one device, there are various problems to be improved due to the mixing of these members.

### SUMMARY

A device for solving the above-described problem includes a device main body and an outer section that is attached to an outside of the device main body and that constitutes an appearance of the device, wherein the outer section includes a first outer section that constitutes an appearance of a continuous first region and a second outer section that constitutes an appearance of a continuous second region, the first outer section contains a recycled resin material, and the second outer section does not contain the recycled resin material.

A device for solving the above-described problem is a device to which a first outer part that constitutes a part of an appearance of a continuous first region of a first device and that contains a recycled resin material is configured to be mounted, the device including a device main body and an outer section that is attached to an outside of the device main body and that constitutes an appearance of the device, wherein the outer section includes the first outer part and a third outer part that constitutes a part of an appearance of the first region of the first device and replaces the second outer part containing the recycled resin material, the third outer part does not contain the recycled resin material, any one of following conditions (a) to (e) is satisfied, and the conditions (a) to (e) are (a) the first outer part and the third outer part are positioned at different positions in a vertical direction, (b) the first outer part and the third outer part are positioned at different positions in a direction intersecting the vertical direction, (c) the third outer part is positioned at a corner section, (d) a front surface is formed by the first outer part, and (e) an area of the first outer part is equal to or more than half of an area of a first surface.

### BRIEF DESCRIPTION OF THE DRAWINGS

FIG. 1 is a schematic perspective view illustrating a multifunction device as an example of a device.

FIG. 2 is a schematic front cross-sectional view of the multifunction device, with a part thereof cut away.

FIG. 3 is a front view of the multifunction device.

FIG. 4 is a right side view of the multifunction device.

FIG. 5 is a left side view of the multifunction device.

FIG. 6 is a rear view of the multifunction device.

FIG. 7 is a plan view of the multifunction device.

FIG. 8 is a perspective view illustrating a cassette.

FIG. 9 is a schematic perspective view illustrating a second multifunction device as an example of a second device.

FIG. 10 is a front view of the second multifunction device.

FIG. 11 is a right side view of the second multifunction device.

FIG. 12 is a left side view of the second multifunction device.

FIG. 13 is a rear view of the second multifunction device.

FIG. 14 is a plan view of the second multifunction device.

FIG. 15 is a front view illustrating a second multifunction device according to a modification.

FIG. 16 is a front view illustrating a multifunction device according to a modification.

FIG. 17 is a front view illustrating a multifunction device according to a modification different from that of FIG. 16.

FIG. 18 is a front view illustrating a multifunction device according to a modification different from that of FIG. 17.

FIG. 19 is a front view illustrating a multifunction device according to a modification different from that of FIG. 18.

FIG. 20 is a front view illustrating a multifunction device according to a modification different from that of FIG. 19.

FIG. 21 is a front view illustrating a multifunction device according to a modification different from that of FIG. 20.

FIG. 22 is a perspective view illustrating a device according to a modification.

FIG. 23 is a front view illustrating a device according to a modification different from that of FIG. 22.

### DESCRIPTION OF EMBODIMENTS

Hereinafter, a device according to an embodiment will be described with reference to the drawings.

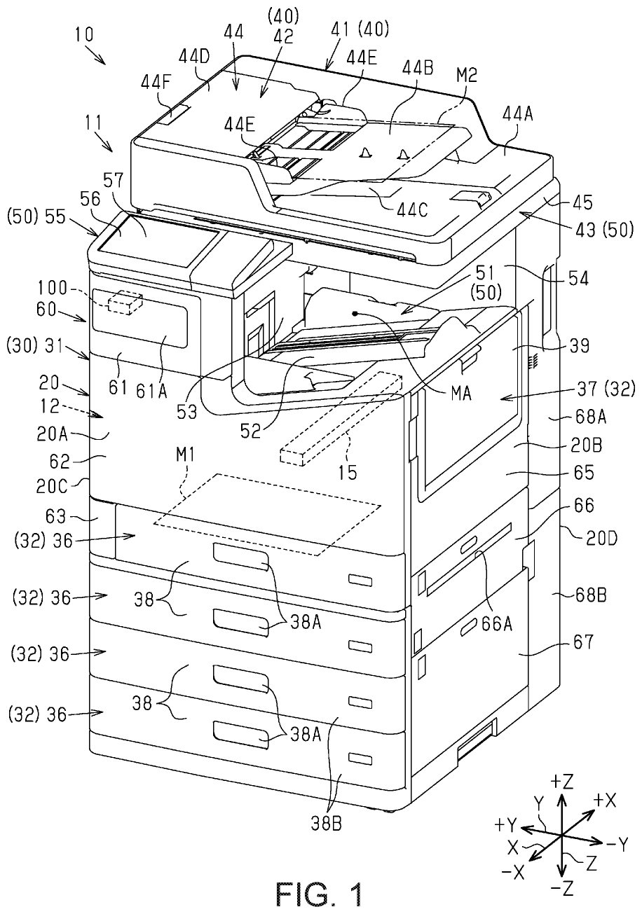

A device 10 according to the present embodiment is, for example, a multifunction device 11 illustrated in FIG. 1. The multifunction device 11 is an example of a device that performs a predetermined process on a medium. In FIG. 1, the multifunction device 11 is placed on a horizontal plane. Two axes parallel to the horizontal plane and orthogonal to each other are defined as an X-axis and a Y-axis, respectively. An axis orthogonal to the horizontal plane is defined as a Z-axis. Directions parallel to the X-axis, the Y-axis, and the Z-axis are referred to as an X direction, a Y direction, and a Z direction, respectively. The X direction includes both a +X direction and a −X direction. The Y direction includes both a +Y direction and a −Y direction. The Z direction includes both a +Z direction and a −Z direction. The Z direction, which is a direction parallel to the Z-axis, is also referred to as a vertical direction Z. The X direction is a direction parallel to a depth direction when the multifunction device 11 is viewed from a front surface. The X direction is also a width direction of a medium M1 being transported in the multifunction device 11. The X direction is also referred to as a depth direction X or a medium width direction X. The Y direction is equal to a width direction when the multifunction device 11 is viewed from the front surface, and is therefore also referred to as a width direction Y. The front surface of the multifunction device 11 is a surface that a user faces when the user performs an operation for giving an instruction to the multifunction device 11.

### Configuration of Multifunction Device 11

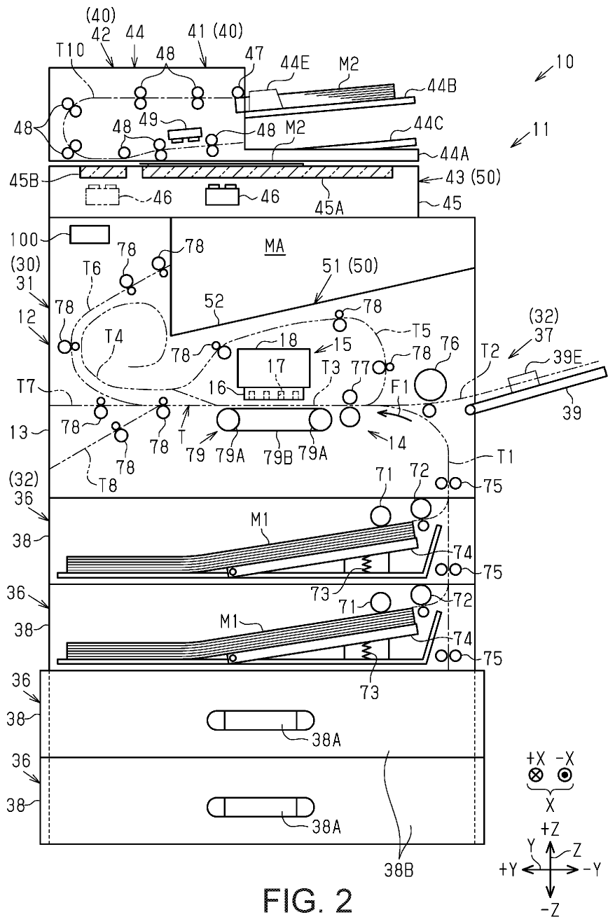

Next, a configuration of the multifunction device 11 will be described with reference to FIG. 1. As illustrated in FIG. 1, the multifunction device 11, which is an example of the device 10, includes a device main body 12 (see FIG. 2) and an outer section 20. The device main body 12 has, for example, a substantially rectangular parallelepiped shape. The outer section 20 is attached to an outside of the device main body 12. The outer section 20 constitutes an appearance of the device 10. The device main body 12 is covered with the outer section 20. The outer section 20 is made of a synthetic resin material. The outer section 20 is constituted by a plurality of outer parts including, for example, a panel, a cover, and the like. The multifunction device 11 has a substantially rectangular parallelepiped shape. The multifunction device 11 has a plurality of surfaces including a surface of the outer section 20. The multifunction device 11 includes a front surface 20A, a right side surface 20B, a left side surface 20C, and a rear surface 20D. The front surface 20A is a surface on a front side (−X direction side) intersecting the depth direction X. The right side surface 20B is a surface on a right side (−Y direction side) intersecting the width direction Y. The left side surface 20C is a surface on a left side (+Y direction side) intersecting the width direction Y. The rear surface 20D is a surface on a rear side (+X direction side) intersecting the depth direction X. The outer section 20 may partially contain an outer part made of a metal material.

In an example illustrated in FIG. 1, the device main body 12 includes a first processing device 30 that performs a first process and a second processing device 40 that performs a second process. The first processing device 30 may be larger in size than the second processing device 40. The second processing device 40 may be arranged above the first processing device 30. The device main body 12 may include another processing device at a position between the first processing device 30 and the second processing device 40. The other processing device may be a third processing device 50 (to be described later).

In an example illustrated in FIG. 1, the first processing device 30 is a printing device 31. The second processing device 40 is an image reading device 41. The printing device 31 is larger in size than the image reading device 41. The first processing device 30 may be a processing device that constitutes a part of the printing device 31. The second processing device 40 may be a processing device that constitutes a part of the image reading device 41.

The printing device 31 is, for example, a printer. The printing device 31 includes a print processing device 15 in the device main body 12. The printing device 31 performs a printing process of printing on the medium M1 as the first process. The medium M1 is, for example, a paper sheet.

The printing device 31 includes one or more cassettes 38. The cassette 38 can accommodate a plurality of sheets of the medium M1 in a stacked state. The printing device 31 supplies the medium M1 from the cassette 38 along a transport path T (see FIG. 2) in the device main body 12 toward a printing position where the print processing device 15 performs printing. The printing device 31 includes a feed tray 39 on which the medium M1 can be placed. The printing device 31 supplies the medium M1 from the feed tray 39 along the transport path T (see FIG. 2) in the device main body 12 toward the printing position where the print processing device 15 performs printing. The print processing device 15 prints on the medium M1 at the printing position in the middle of the transport path T (see FIG. 2) of the medium M1.

The image reading device 41 is, for example, a scanner. The image reading device 41 performs an image reading process of reading an image on a medium M2 as the second process. The medium M2 is, for example, a document. The image reading device 41 may include an automatic document feeding device 44 (ADF(automatic document feeder)) that transports the medium M2 such as a document. In this case, the image reading device 41 may include a sheet feed type first image reading device 42 including the automatic document feeding device 44 (hereinafter also referred to as “ADF device 44”), and a flatbed type second image reading device 43. The second processing device 40 may be a part of a processing devices that constitutes the second processing device 40. The second processing device 40 may be the first image reading device 42 including the ADF device 44 arranged on an upper side of the second processing device 40. The medium M2 may be a booklet such as a book or pamphlet.

The multifunction device 11 has a printing function, a scan function, and a copy function. The printing function is a function of the printing device 31 printing on the medium M1 such as a paper sheet. The scan function is a function of the image reading device 41 reading an image on the medium M2 such as a document. The copy function is a function in which the printing device 31 prints an image of the medium M2 such as a document read by the image reading device 41 onto the medium M1 such as a paper sheet. The multifunction device 11 may have a facsimile function.

An outer section that constitutes an appearance of the first processing device 30 (printing device 31) includes a first outer section 21 that is a part of the outer section 20 of the multifunction device 11. The second processing device 40 (image reading device 41) includes an outer section that constitutes an appearance. The outer section of the second processing device 40 includes a second outer section 22 that is a part of the outer section 20 of the multifunction device 11. The first outer section 21 is made of a recycled resin material. That is, the first outer section 21 is made of a recycled material made of a recycled resin material. The second outer section 22 is made of a non-recycled resin material that does not contain a recycled resin material. That is, the second outer section 22 is made of a general material that is a non-recycled material made of a non-recycled resin material.

The outer section of the first processing device 30 (printing device 31) includes the first outer section 21 having a continuous first region A1 as an appearance. The outer section of the second processing device 40 (for example, the first image reading device 42) includes the second outer section 22 having a continuous second region A2 as an appearance. In this manner, the first outer section 21 made of a recycled material and the second outer section 22 made of a general material may be separated for each processing devices 30 and 40.

The printing device 31, which is an example of the first processing device 30, may include a plurality of processing devices. That is, the printing device 31 may be an assembly of a plurality of processing devices. The printing device 31 performs, as the printing process that is the first process, supplying of the medium M1, transporting of the medium M1, printing on the medium M1, discharging of the medium M1, stacking of the medium M1, and the like. Therefore, the printing device 31 may include a plurality of processing devices that perform each process such as supplying, transporting, printing, discharging, and stacking of the medium M1.

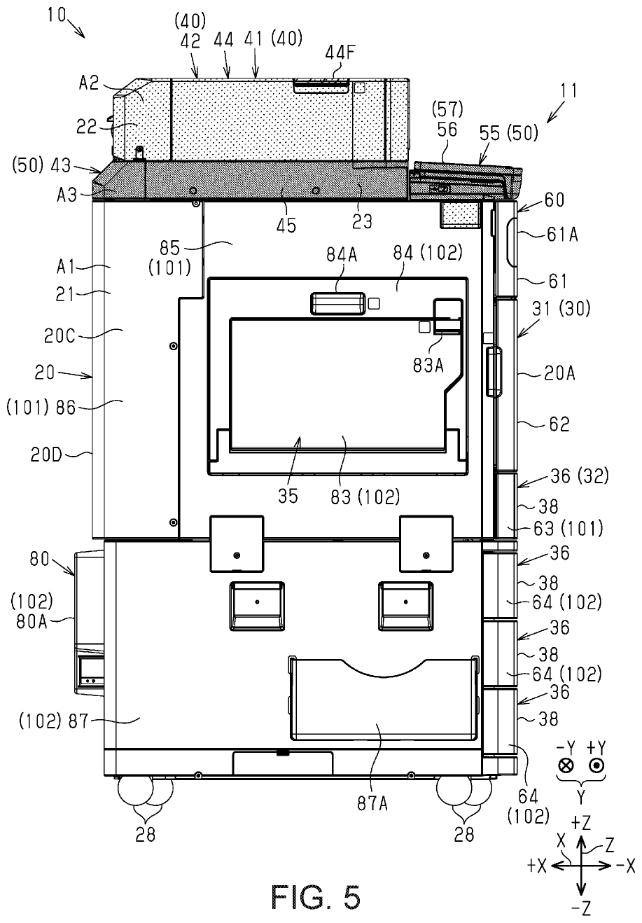

That is, the printing device 31 may include a medium supply device 32, a transport device 14 (see FIG. 2), a print processing device 15 (see FIG. 2), a medium discharge device 35 (see FIG. 5), and a printing material supply device 60 (see FIG. 1) as the processing devices. The printing device 31 may include a first medium supply device 36 and a second medium supply device 37 as the medium supply device 32.

As illustrated in FIG. 1, the first medium supply device 36 includes the cassette 38. The cassette 38 is configured to be attachable to and detachable from the device main body 12. The cassette 38 is attached and detached in a direction parallel to the depth direction X. The cassette 38 illustrated in FIG. 2 is in a state of being inserted into the device main body 12. The cassette 38 includes a handle section 38A. The handle section 38A may be provided at a predetermined position on a front wall section 38B of the cassette 38. The predetermined position may be a substantially central position on the front wall section 38B of the cassette 38. In a state where the cassette 38 is inserted into the device main body 12, the front wall section 38B is exposed to an outside.

The cassette 38 can accommodate a plurality of sheets of medium M1 in a stacked state. The first medium supply device 36 supplies sheets of medium M1 in the cassette 38 one by one toward the printing position where the print processing device 15 can perform printing. The printing device 31 may include a plurality of first medium supply devices 36. In an example illustrated in FIG. 1, the printing device 31 includes four first medium supply devices 36. The number of the first medium supply devices 36 may be two, three, five or more, or may be only one.

The second medium supply device 37 includes the feed tray 39. The feed tray 39 is configured to be openable and closable. In FIG. 1, the feed tray 39 is in a closed state in which a rear surface of the feed tray 39 is stored in parallel with the right side surface 20B. The feed tray 39 is attached to the device main body 12 so as to be pivotable within a predetermined angle range between the closed state illustrated in FIG. 1 and an opened state illustrated in FIG. 2. The feed tray 39 includes an edge guide 39E that can position the medium M1 in the medium width direction X in the opened state. The second medium supply device 37 feeds sheets of the medium M1 placed on the feed tray 39 one by one toward the printing position of the print processing device 15.

The printing material supply device 60 is configured to be capable of supplying a printing material such as ink to the print processing device 15. The printing material supply device 60 includes a printing material cover 61. The printing material cover 61 includes a window section 61A made of a transparent material. The transparent material of the window section 61A may be a synthetic resin material or glass. The printing material cover 61 can be opened and closed by, for example, pivoting about a pivot axis parallel to the Z-axis with a right end section as the center.

A main body cover 62 is provided on a lower side of a stacking device 51 and the printing material supply device 60 on the front surface 20A of the printing device 31. The main body cover 62 can be opened and closed by, for example, pivoting about a pivot axis parallel to the Z-axis with a right end section as the center. The main body cover 62 is opened when a jam of the medium M1 is to be cleared when a jam occurs.

The printing device 31 includes maintenance covers 65 to 67 on the right side surface 20B. That is, the printing device 31 includes a first maintenance cover 65, a second maintenance cover 66, and a third maintenance cover 67 in order from the top on the right side surface 20B. The first maintenance cover 65 is positioned at an upper part of the right side surface 20B and is formed in a region including the feed tray 39. The first maintenance cover 65 is configured to open and close the entire region including the feed tray 39. When the first maintenance cover 65 is in an opened state, the transport path T (see FIG. 2) is exposed. The first maintenance cover 65 is opened when the medium M1 supplied from the cassette 38 or the medium M1 fed from the feed tray 39 is to be cleared from a jammed state near an upper position.

The second maintenance cover 66 is positioned at a middle part below the first maintenance cover 65. The second maintenance cover 66 includes a supply port 66A through which the medium M1 can be supplied from an outside. For example, the multifunction device 11 may be used in a configuration in which a large capacity medium supply device (not illustrated) is arranged on a right side. In this case, the medium supply device supplies the medium M1 into the multifunction device 11 through the supply port 66A. The second maintenance cover 66 is configured to be openable and closable. When the second maintenance cover 66 is in an opened state, the transport path T (see FIG. 2) is exposed. The second maintenance cover 66 is opened when the medium M1 supplied from the cassette 38 or the medium M1 supplied from the medium supply device is to be cleared from a jammed state near a middle position.

The third maintenance cover 67 is positioned at a lower part below the second maintenance cover 66. The third maintenance cover 67 is configured to be openable and closable. When the third maintenance cover 67 is in an opened state, the transport path T (see FIG. 2) is exposed. The third maintenance cover 67 is opened when the medium M1 supplied from the cassette 38 is to be cleared from a jammed state near a lower position. The printing device 31 includes panels 68A and 68B arranged above and below at a position near a rear end of the right side surface 20B.

The cassettes 38, the feed tray 39, the printing material cover 61, the main body cover 62, the first maintenance cover 65, the second maintenance cover 66, the third maintenance cover 67, and the panels 68A and 68B constitute the outer section of the printing device 31. The outer section of the printing device 31 is also formed in a region extending over the left side surface 20C and the rear surface 20D, which are hidden in FIG. 1. The outer section of the printing device 31 constitutes a part of the outer section 20 of the multifunction device 11.

As illustrated in FIG. 1, the first image reading device 42 is arranged above the second image reading device 43. A bottom section of the first image reading device 42 also serves as a document cover 44A of the second image reading device 43. In other words, the first image reading device 42 is mounted on the document cover 44A of the second image reading device 43. The ADF device 44 is configured to be openable and closable with respect to the second image reading device 43.

The second image reading device 43 includes a document table 45 on which the medium M2 such as a document can be placed. The document cover 44A can be opened and closed together with the ADF device 44 with respect to the document table 45. When the document cover 44A is opened, a placement surface (not illustrated) made of a glass plate is exposed on an upper surface of the document table 45. The second image reading device 43 reads the medium M2 placed on the placement surface of the document table 45 by a user in a state where the document cover 44A is closed.

In the present embodiment, the second processing device 40 may be the sheet feed type first image reading device 42 including the ADF device 44 arranged on an upper side of the image reading device 41. The ADF device 44 may include a document tray 44B, a document stacker 44C, and a maintenance cover 44D. The document tray 44B includes edge guides 44E that can position the medium M2, such as a document, in the medium width direction.

The ADF device 44 feeds sheets of the medium M2 such as a plurality of documents stacked on the document tray 44B one by one. An image on the medium M2 fed by the ADF device 44 is read in the middle of the transport path, and then the medium M2 is discharged from the ADF device 44 onto the document stacker 44C. The ADF device 44 includes an opening and closing lever 44F capable of opening and closing the maintenance cover 44D. When a jam of the medium M2 occurs in the ADF device 44, a user operates the opening and closing lever 44F to open the maintenance cover 44D, and removes the jammed medium M2 from the transport path that is exposed.

As illustrated in FIG. 1, the device main body 12 may include the third processing device 50 positioned between the first processing device 30 and the second processing device 40. That is, the device main body 12 may include the third processing device 50 positioned between the printing device 31 and the image reading device 41. The third processing device 50 is a device that performs a third process. In particular, in the present embodiment, the second processing device 40 may be the sheet feed type first image reading device 42. In this case, the third processing device 50 may be positioned between the sheet feed type first image reading device 42 in the image reading device 41 and the printing device 31.

In this case, the third processing device 50 may be positioned between the first processing device 30 and the second processing device 40 in a surface in which the multifunction device 11 is viewed from any one of the four sides. One side view surface may be the front surface 20A. The front surface 20A of the multifunction device 11 is a surface on which a user who uses the multifunction device 11 frequently views the multifunction device 11. The front surface 20A of the multifunction device 11 is more important in the appearance and design than the side surfaces 20B and 20C, which are the other surfaces of the multifunction device 11 as viewed from the side. The two side surfaces 20B and 20C are next to the front surface 20A in that the appearance and design are important. The appearance and design of the rear surface 20D are not as important as those of the three surfaces, that is, the surfaces 20A, 20B, and 20C.

The third processing device 50 may be the stacking device 51. The stacking device 51 stacks the medium M1 as the third process. The stacking device 51 is, for example, a stacker. The stacking device 51 includes a medium discharge space MA formed between the first processing device 30 and the second processing device 40. The stacking device 51 includes a stacking table 52. The stacking table 52 constitutes a bottom section of the medium discharge space MA and is formed in a slope shape. The stacking device 51 includes a discharge plate section 53 in which a discharge port (not illustrated) through which the printed medium M1 are discharged is opened, and a back plate section 54 on a rear surface side. The discharge plate section 53 and the back plate section 54 form a part of an inner wall surface of the medium discharge space MA.

The third processing device 50 may be an operation device 55. The operation device 55 includes an operation section 56 that can be operated by a user. The operation device 55 performs, as the third process, an input process of receiving input information input by a user operating the operation section 56. The operation device 55 may include a display device 57. A display panel of the display device 57 may be, for example, a touch panel. In this case, the operation section 56 may be a touch panel operation section that allows a user to input input information by touching a screen of the display device 57. The operation section 56 may be an operation switch or an operation button including a mechanical switch.

The third processing device 50 may be the flatbed type second image reading device 43. When the second processing device 40 is the sheet feed type first image reading device 42, a device portion other than the first image reading device 42 in the image reading device 41 may be the third processing device 50. As described above, the third processing device 50 may be the second image reading device 43 positioned on a first processing device 30 (printing device 31) side among the first image reading device 42 and the second image reading device 43 constituting the image reading device 41.

In an example illustrated in FIG. 1, the multifunction device 11 includes N processing devices including one first processing device 30, one second processing device 40, and three third processing devices 50. That is, the multifunction device 11 includes the printing device 31, the first image reading device 42, the second image reading device 43, the stacking device 51, and the operation device 55 as N (for example, five) processing devices.

The multifunction device 11 includes a control section 100 in the device main body 12. The control section 100 controls a plurality of processing devices including the first processing device 30, the second processing device 40, and the third processing device 50. The control section 100 controls, for example, the printing device 31, which is an example of the first processing device 30. Specifically, the control section 100 controls the first medium supply device 36, the second medium supply device 37, the transport device 14, and the print processing device 15 that constitute the printing device 31.

The control section 100 controls, for example, the image reading device 41, which is an example of the second processing device 40. Specifically, the control section 100 controls the first image reading device 42 including the ADF device 44 and the second image reading device 43. The control section 100 controls the ADF device 44 to feed sheets of the medium M2 such as documents placed on the document tray 44B one by one. The first image reading device 42 reads an image on the medium M2 transported by the ADF device 44.

The control section 100 controls the image reading device 43 and the operation device 55. The control section 100 controls the image reading device 43 to read an image of the medium M2 such as a document placed on the document table 45. The control section 100 receives input information input to the operation device 55 by a user operating the operation section 56. The control section 100 controls the display device 57 of the operation device 55 to display information on the screen of the display device 57.

The processing devices constituting the device 10 are not limited to control targets of the control section 100. The processing device may perform at least one of an electrical process, a mechanical process, and a physical process. The stacking device 51 is an example of a processing device that performs the physical process. The stacking device 51 performs a stacking process of stacking the medium M1 on the stacking table 52 in an alignment state by a physical process in which the medium M1 slides on the inclined stacking table 52 due to the gravity by discharging the medium M1 after printing to the inclined stacking table 52. Specifically, the stacking device 51 causes the medium M1 to slide toward a lower side on the stacking table 52 by using the gravity of the medium M1, and thus a rear end section of the medium M1 in a discharge direction abuts against a restriction surface provided in a lower section of the discharge plate section 53. By this, the stacking device 51 performs the stacking process of stacking a plurality of sheets of the medium M1 in the alignment state in which the rear end sections of sheets of the discharged medium M1 are aligned.

### Internal Configuration of Multifunction Device 11

Next, an internal configuration of the multifunction device 11 will be described with reference to FIG. 2. Since internal configurations of the plurality of cassettes 38 are basically the same, only the upper two cassettes 38 are illustrated in cross-section in FIG. 2.

The device main body 12 includes a mechanism section that performs a predetermined process and a frame structure 13 that surrounds the mechanism section. An outer surface of the device main body 12 is formed by, for example, a frame plate or the like that constitutes the frame structure 13. The frame structure 13 may include an opening section at a portion corresponding to the openable feed tray 39, the covers 65 to 67, and the like.

The frame structure 13 includes, for example, a frame (not illustrated) mainly made of metal. The frame structure 13 may include a main body constituting member (not illustrated) made of a synthetic resin material assembled to the frame. The mechanism section in the device main body 12 may include the first medium supply device 36, the second medium supply device 37, the transport device 14, and the print processing device 15, which will be described later. The first medium supply device 36, the second medium supply device 37, the transport device 14, and the like may include an outer section of each device attached to an outside of the device main body 12 as a part of the outer section 20.

The transport device 14 transports the medium M1 along the transport path T. The transport device 14 transports the medium M1 fed from the medium supply devices 36 and 37 along the transport path T. The transport path T includes a first feed path T1, a second feed path T2, a transport path T3, a switchback path T4, an inversion path T5, a first discharge path T6, a second discharge path T7, and a third discharge path T8. A direction along the transport path T on which the medium M1 is transported is a transport direction F1. The transport direction F1 may be, for example, a direction orthogonal to the medium width direction X. The transport direction F1 may change depending on a position on the transport path T.

The first feed path T1 is a path on which the medium M1 from the cassette 38 is fed. The second feed path T2 is a path on which the medium M1 is fed from the feed tray 39. The transport path T3 is a path for transporting the fed medium M1. The printing position is positioned in the middle of the transport path T3. The switchback path T4 is a path on which the medium M1 printed on a first surface is switched back and transported during double-sided printing. The inversion path T5 is a path for inverting the medium M1 that was switched back and transported. The inversion path T5 merges with the transport path T3 at a position upstream of the printing position. The first discharge path T6 is a path on which the medium M1 discharged to the stacking table 52 is transported. The second discharge path T7 is a path on which the medium M1 discharged to a discharge tray 83 (see FIG. 5) is transported. The third discharge path T8 is a path on which the medium M1 discharged to an external device (not illustrated) is transported. The external device is, for example, a device that performs a predetermined process on the medium M1 after printing. The external device is, for example, a post-processing device or an intermediate processing device that inverts or dries the medium M1 to be sent to the post-processing device.

The first medium supply device 36 includes a feed roller 71 and a separation roller pair 72 at an upper position of a downstream end section in a feed direction of the cassette 38 inserted into the device main body 12. The cassette 38 includes a hopper 74 capable of placing the medium M1 in a stacked state in its accommodation section. The hopper 74 is provided to be tiltable in a state of being biased to a +Z side (upper side) by a spring 73. In a state where the cassette 38 is inserted into the device main body 12, the hopper 74 is tilted to the +Z side (upper side) by a biasing force of the spring 73, and thus, the uppermost sheet of a plurality of sheets of the medium M1 accommodated in the cassette 38 comes into contact with the feed roller 71. In this state, the feed roller 71 rotates, and thus the uppermost sheet of the plurality of sheets of the medium M1 is fed in the feed direction. The separation roller pair 72 rotates while nipping the fed medium M1. Even if a plurality of sheets of the medium M1 are fed, the separation roller pair 72 separates only one sheet by the separation action and feeds the sheet downstream. In this way, the medium M1 fed from the cassette 38 is sent to the transport path T3 through the first feed path T1 by a transport roller pair 75.

The second medium supply device 37 includes the above-described feed tray 39 and a feed roller pair 76 positioned inside the device main body 12. The feed tray 39 may include the edge guide 39E that can position the medium M1 placed on the feed tray 39 in the medium width direction X. The feed roller pair 76 is arranged at a position downstream of the feed tray 39 in a feed direction. The feed roller pair 76 may include a feed roller having a large diameter and a separation roller having a small diameter. The feed roller pair 76 separates the uppermost sheet of sheets of the medium M1 placed on the feed tray 39 and feeds the sheet from the feed path T2 to the transport path T3.

The transport device 14 includes a plurality of roller pairs 75 to 78 arranged along the transport path T. That is, the transport device 14 includes the plurality of transport roller pairs 75 arranged along the first feed path T1. The transport device 14 includes the feed roller pair 76 arranged at a predetermined position on the second feed path T2. The transport device 14 includes a transport roller pair 77 arranged upstream in the transport direction F1 from the printing position on the transport path T3 that faces the print processing device 15. The transport roller pair 77 is, for example, a registration roller. The transport device 14 eliminates a skew of the medium M1 by causing a leading edge of the medium M1 to abut against the transport roller pair 77. The transport roller pair 77 transports the medium M1, in which a skew is eliminated, to the printing position on the transport path T3.

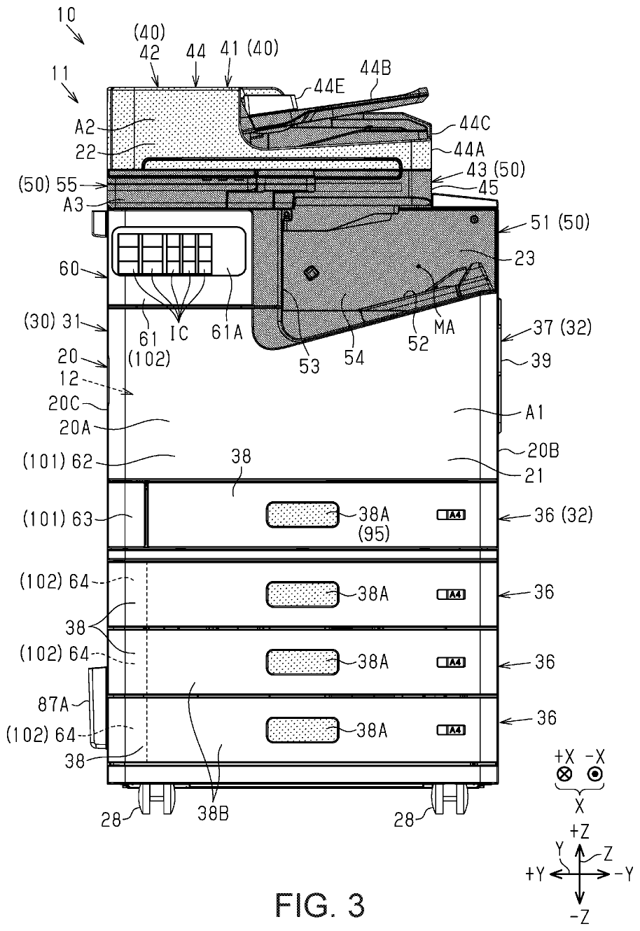

The print processing device 15 prints on the medium M1 being transported along the transport path T. The print processing device 15 includes a print head 16 that prints on the medium M1 at the printing position on the transport path T3. The print head 16 may be an inkjet type liquid ejection head that ejects liquid such as ink. The print head 16 may include nozzles 17 capable of ejecting liquid. The print processing device 15 may include a holding section 18 that holds the print head 16 at a position with a predetermined gap from the medium M1. The printing device 31 may include the printing material supply device 60 to which liquid cartridges IC, which are examples of liquid supply sources, are mounted (see FIG. 3 for both). The print head 16 may eject liquid such as ink supplied from the liquid cartridges IC through tubes (not illustrated) from the nozzles 17. The liquid supply source is the liquid cartridge IC such as an ink cartridge, but may be a liquid tank that accommodates liquid such as ink. The liquid tank is, for example, an ink tank.

The print head 16 may be a line head. That is, the print processing device 15 may be a line printing type print processing device that includes, as the print head 16, a long line head that is longer in the medium width direction X than a width of the medium M1. In the line printing type, the print head 16, which is a line head, ejects droplets from the nozzles 17 onto the medium M1 being transported at a constant speed.

The print head 16 may be a serial head. That is, the print processing device 15 may be a print processing device of a serial printing type in which the holding section 18 that holds the print head 16 is a carriage movable in the medium width direction X. In the serial printing type, printing of one line by the print head 16 by moving the carriage and a transport operation of intermittently transporting the medium M1 to a position where the next printing is performed are alternately performed.

A medium support section 79 is arranged at a position facing the print head 16 across the transport path T3. The medium support section 79 may be a transport belt mechanism illustrated in FIG. 2. The medium support section 79 including the transport belt mechanism may constitute a part of the transport device 14. The transport belt mechanism includes a pair of rollers 79A and a transport belt 79B wound around the outer periphery of the pair of rollers 79A. A surface of the transport belt 79B that faces the print head 16 serves as a support surface that supports the medium M1 during transport. The medium support section 79 may be a support table such as a platen.

The print head 16 ejects liquid such as ink toward a portion of the medium M1 that is supported on the support surface of the medium support section 79 and that is transported along the transport direction F1. By this, the print head 16 prints characters, images, or the like on the medium M1. The medium M1 printed by the print head 16 are transported downstream in the transport direction F1 by the transport belt 79B. Note that the print head 16 is arranged in a horizontal posture, but in a configuration in which the transport path T at the printing position is not horizontal, the print head 16 may be arranged in a posture that is inclined at a predetermined angle with respect to the horizontal.

Printing includes single-sided printing in which printing is performed on a first surface of the medium M1, and double-sided printing in which printing is performed on the first surface and a second surface of the medium M1. The second surface of the medium M1 is a surface opposite to the first surface. In a case of single-sided printing, the medium M1 after printing is discharged to any of the discharge paths T6 to T8. On the other hand, in a case of double-sided printing, the medium M1 after printing is sent to the switchback path T4 and the inversion path T5. A plurality of transport roller pairs 78 are arranged along the switchback path T4, the inversion path T5, and the discharge paths T6 to T8. The transport device 14 may include a plurality of rollers (not illustrated) arranged along the transport path T.

The medium M1 sent to the switchback path T4 is switched back and transported. A switchback transport is a transport operation of transporting and reversely transporting the medium M1 along the switchback path T4. The medium M1 that was reversely transported through the switchback path T4 is sent to the inversion path T5. The medium M1 is reversed in the direction of front and back surfaces while passing through the inversion path T5. The reversed medium M1 is transported to the printing position in an orientation that allows the second surface, which is a surface opposite to the printed first surface, to face the print head 16. The print head 16 prints on the second surface of the medium M1 at the printing position. The medium M1 on which the double-sided printing was performed is sent to any one of the discharge paths T6 to T8. A discharge destination of the discharge paths T6 to T8 is determined based on, for example, printing condition information included in a print job input by the control section 100. The transport device 14 may include a flap (not illustrated) capable of selecting a path at a position corresponding to a branch position of each of the paths T1 to T8.

### Configuration of Outer Section of Device 10

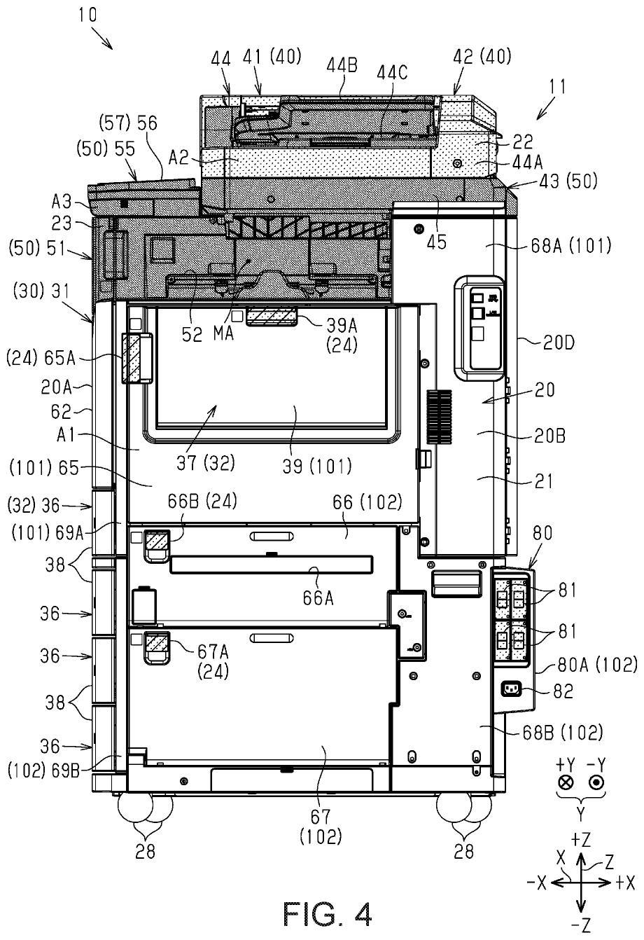

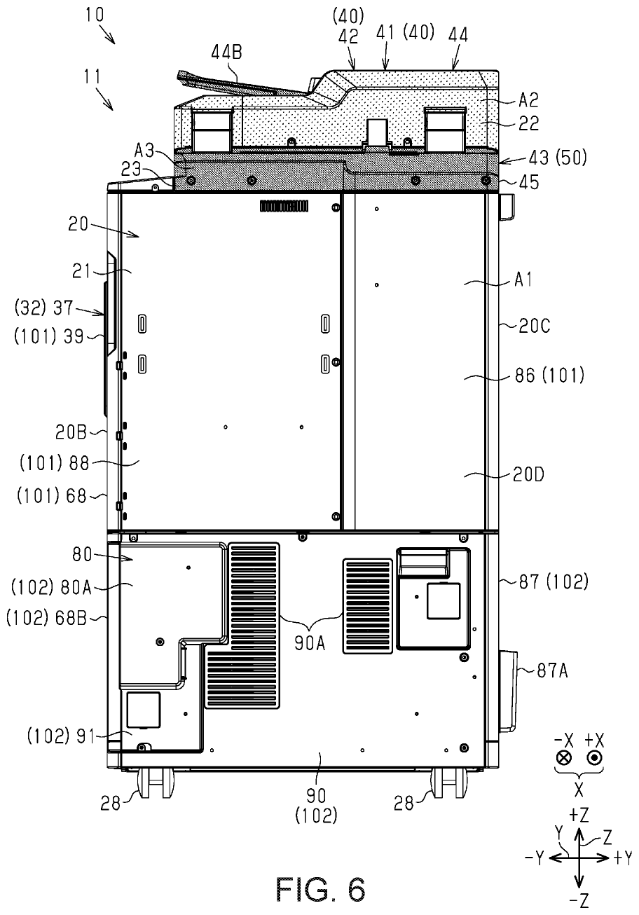

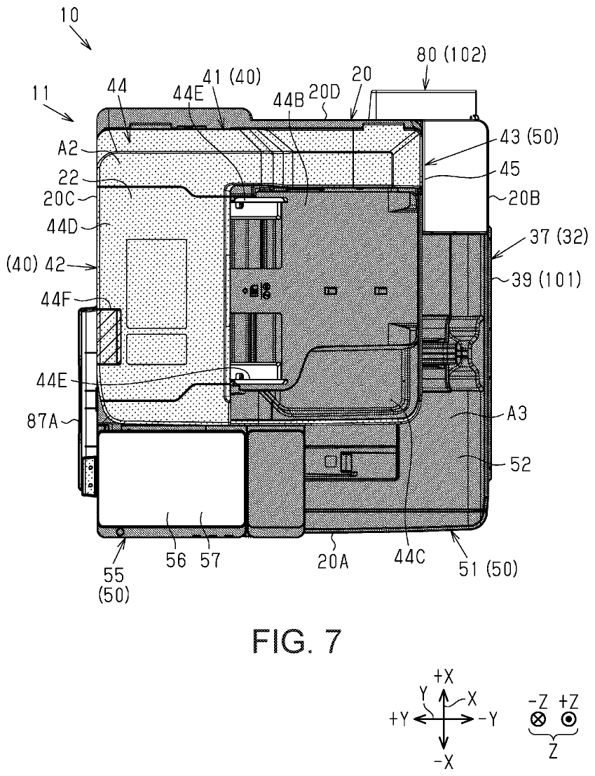

Next, the outer section 20 of the multifunction device 11, which is an example of the device 10, will be described with reference to FIGS. 3 to 7. FIG. 3 is a front view of the multifunction device 11. FIG. 4 is a right side view of the multifunction device 11. FIG. 5 is a left side view of the multifunction device 11. FIG. 6 is a rear view of the multifunction device 11. FIG. 7 is a plan view of the multifunction device 11. The outer section 20 may be made of the synthetic resin material. The outer section 20 includes a recycled material portion made of a recycled resin material and a non-recycled material (general material) portion made of a non-recycled resin material. In the multifunction device 11 illustrated in FIGS. 3 to 7, a portion made of a recycled material and a portion made of a non-recycled material (general material) in the outer section 20 are distinguished by the presence or absence of a dot pattern or the like. In the outer section 20, a white region without dots is a region of the recycled material made of the recycled resin material. In the outer section 20, a light dot region to which light dots are applied is a region of the non-recycled material not containing the recycled resin material. A portion of the recycled material, which is the white region, and a portion of the non-recycled material, which is the light dot region, in the outer section 20 both exhibit a first color. The first color is, for example, a light color. The light color is a color having a higher brightness than an intermediate color. In the present embodiment, the first color is, for example, white. Furthermore, an outer section indicated by a dark dot region to which dark dots are applied in the outer section 20 exhibits a second color different from the first color. The second color has a lower brightness than the first color. The second color is, for example, a dark color. The dark color is a color having a lower brightness than the intermediate color. In the present embodiment, the second color is, for example, black. The dark dot region may be the recycled material or the non-recycled material.

As illustrated in FIGS. 3 to 6, the outer section 20 includes the first outer section 21 that constitutes an appearance of the continuous first region A1 and the second outer section 22 that constitutes an appearance of the continuous second region A2. The first region A1 is indicated by a continuous white region in FIGS. 3 to 6. The first outer section 21, an appearance of which is constituted by the first region A1, contains the recycled resin material. That is, the first outer section 21 is made of the recycled material. The outer section 20 includes an outer member made of one or more recycled materials and an outer member made of one or more non-recycled materials. The first outer section 21 may be constituted by one or more outer members forming the continuous first region A1 among one or more outer members made of the recycled material constituting the outer section 20.

The first outer section 21 may include the first region A1 at least on the front surface 20A among the four surfaces 20A to 20D when the multifunction device 11 is viewed from the side. The first outer section 21 may include the first region A1 for each of the four surfaces 20A to 20D of the multifunction device 11. Each first region A1 of each of the four surfaces 20A to 20D may be continuous with the first region A1 of the adjacent surface. That is, the first outer section 21 may be continuous over a plurality of surfaces among the four surfaces 20A to 20D. Further, as in examples illustrated in FIGS. 3 to 6, the first outer section 21 may be continuous over all of the four surfaces 20A to 20D.

The second region A2 is indicated by the continuous light dot region in FIGS. 3 to 7. The second outer section 22, an appearance of which is constituted by the second region A2, does not contain the recycled resin material. That is, the second outer section 22 is made of the non-recycled material made of the non-recycled resin material. The non-recycled material is also referred to as the general material. The second outer section 22 may be constituted by one or more outer members forming the continuous second region A2 among one or more outer members made of the non-recycled material constituting the outer section 20. As illustrated in FIGS. 3 to 6, the second outer section 22 may include the second region A2 at least on the front surface 20A among the four surfaces 20A to 20D when the multifunction device 11 is viewed from the side. The second outer section 22 may include the second region A2 for each of the four surfaces 20A to 20D of the multifunction device 11. Each second region A2 of each of the four surfaces 20A to 20D may be continuous with the second region A2 of the adjacent surface. That is, the second outer section 22 may include the second region A2 that is continuous over a plurality of surfaces among the four surfaces 20A to 20D. The second region A2 may be a region continuous over all of the four surfaces 20A to 20D as in examples illustrated in FIGS. 3 to 6. That is, the second outer section 22 may be continuous over the entire perimetral direction of the multifunction device 11.

When the outer section 20 of the device 10 includes a configuration in which the recycled material and the non-recycled material (general material) are mixed, the first outer section 21 made of the recycled material and the second outer section 22 made of the non-recycled material may have slightly different appearances. For example, when the first outer section 21 and the second outer section 22 have the same color, the recycled material and the non-recycled material may have different colors. In the present embodiment, the first outer section 21 and the second outer section 22 are set by changing whether the material is the recycled material or the non-recycled material for each of the continuous regions A1 and A2. By this, even when the recycled material and the non-recycled material are mixed in the outer section 20 of the multifunction device 11, the difference in appearance between the first outer section 21 and the second outer section 22 is less likely to be noticeable. In this way, the usage rate of the recycled resin material (hereinafter, also referred to as “recycled material usage rate”) of the multifunction device 11 is increased while an aesthetic appearance of the multifunction device 11 is prevented from being impaired.

The first outer section 21 constitutes at least a part of an appearance of the first processing device 30. Specifically, the first outer section 21 constitutes at least a part of an appearance of the printing device 31. The first outer section 21 is constituted by one or more outer members made of the recycled material forming the continuous first region A1 among the plurality of outer members. In examples illustrated in FIGS. 3 to 6, the first outer section 21 includes the first region A1 as an appearance, which is indicated as the continuous white region. The first outer section 21 occupies 90% or more of an outer area of the printing device 31. The first outer section 21 may be configured to occupy 70% or more of the outer area of the printing device 31, or may be configured to occupy exceeding half (50%) of the outer area of the printing device 31. Further, the first outer section 21 may be configured to occupy 50% or less of the outer area of the printing device 31.

For example, in the front surface 20A of the multifunction device 11 illustrated in FIG. 3, the first outer section 21, which is the continuous white region, occupies 70% or more of an outer area of the printing device 31, which is an example of the first processing device 30. In particular, in an example illustrated in FIG. 3, the first outer section 21 occupies 90% or more of the outer area of the printing device 31. For example, in the right side surface 20B of the multifunction device 11 illustrated in FIG. 4, the first outer section 21, which is the continuous white region, occupies 70% or more of an outer area of the printing device 31, which is an example of the first processing device 30. In particular, in the example illustrated in FIG. 4, the first outer section 21 occupies 90% or more of the outer area of the printing device 31. For example, in the left side surface 20C of the multifunction device 11 illustrated in FIG. 5, the first outer section 21, which is the continuous white region, occupies 70% or more of an outer area of the printing device 31, which is an example of the first processing device 30. In particular, in the example illustrated in FIG. 5, the first outer section 21 occupies 90% or more of the outer area of the printing device 31. For example, in the rear surface 20D of the multifunction device 11 illustrated in FIG. 6, the first outer section 21, which is the continuous white region, occupies 70% or more of an outer area of the printing device 31, which is an example of the first processing device 30. In particular, in the example illustrated in FIG. 6, the first outer section 21 occupies 90% or more of the outer area of the printing device 31. Therefore, in the entire side perimetral surface (entire perimetral direction) of the multifunction device 11, the first outer section 21 occupies, for example, 70% or more of the entire side perimetral surface of the printing device 31, which is an example of the first processing device 30. In particular, in the entire side perimetral surface of the multifunction device 11, the first outer section 21 occupies, for example, 90% or more of the entire side perimetral surface of the printing device 31. An area occupied by the first outer section 21 in the entire side perimetral surface of the printing device 31 may be, for example, more than 50% and less than 70%, or less than 50%.

The second outer section 22 constitutes at least a part of an appearance of the second processing device 40. That is, the second outer section 22 is configured by one or more outer members made of the non-recycled material (general material) forming the continuous second region A2 among the plurality of outer members configuring an appearance of the first image reading device 42, which is an example of the second processing device 40. In examples illustrated in FIGS. 3 to 6, the second outer section 22 having the second region A2 indicated by the continuous light dot region as an appearance occupies 90% or more of an outer area of the first image reading device 42, which is an example of the second processing device 40. The second outer section 22 may be configured to occupy 70% or more of the outer area of the second processing device 40, or may be configured to occupy exceeding half (½) of the outer area of the second processing device 40. Further, the second outer section 22 may be configured to occupy at least a part of the outer area of the second processing device 40.

### Reason for Using Non-Recycled Material for Second Processing Device 40

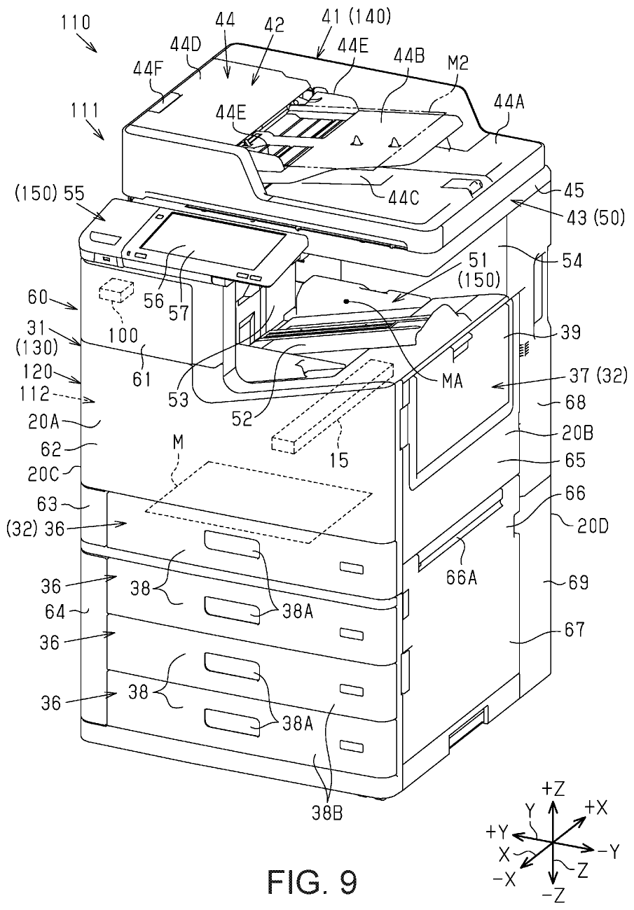

A reason why the non-recycled material is left in a part of the outer section 20 of the multifunction device 11 will be described. In the multifunction device 11 according to the present embodiment, the outer section of the first image reading device 42 is made of the non-recycled material (general material). In other words, the outer section of the ADF device 44 is made of the non-recycled material. The ADF device 44 is a common part that is used in common with other devices other than the device 10. For example, the ADF device 44 is a common part that is used in common with a second device 110 (see FIG. 9) described later. Further, the ADF device 44 is also a common part of a third device (not illustrated) different from the second device 110. When the outer section of the ADF device 44, which is a common part, is made of the recycled material, in at least one of the second device 110 and the third device, there is a possibility that the difference in color tone or the influence on characteristics may occur between the ADF device 44 and an outer member made of the non-recycled material of an adjacent processing device. When the influence on characteristics occurs, it is necessary to evaluate characteristics of the outer section of the ADF device 44. For this reason, the outer section of the ADF device 44 is left as the non-recycled material.

For example, in the front surface 20A of the multifunction device 11 illustrated in FIG. 3, the second outer section 22, which is the continuous light dot region, occupies 50% or more of an outer area of the first image reading device 42, which is an example of the second processing device 40. In particular, in the example illustrated in FIG. 3, the second outer section 22 occupies 70% or more of the outer area of the first image reading device 42. For example, in the right side surface 20B of the multifunction device 11 illustrated in FIG. 4, the second outer section 22 occupies 50% or more of an outer area of the first image reading device 42. In particular, in the example illustrated in FIG. 4, the second outer section 22 occupies 70% or more of the outer area of the first image reading device 42. For example, in the left side surface 20C of the multifunction device 11 illustrated in FIG. 5, the second outer section 22 occupies 90% or more of an outer area of the first image reading device 42. In particular, in the example illustrated in FIG. 5, the second outer section 22 occupies 70% or more of the outer area of the first image reading device 42. For example, in the rear surface 20D of the multifunction device 11 illustrated in FIG. 6, the second outer section 22 occupies 70% or more of an outer area of the first image reading device 42. In particular, in the example illustrated in FIG. 6, the second outer section 22 occupies 90% or more of the outer area of the first image reading device 42.

Therefore, in the entire side perimetral surface (entire perimetral direction) of the multifunction device 11, the second outer section 22 occupies, for example, 70% or more of the entire side perimetral surface of the first image reading device 42. In particular, in the entire side perimetral surface of the multifunction device 11, the second outer section 22 occupies, for example, 80% or more of the entire side perimetral surface of the first image reading device 42. An area occupied by the second outer section 22 in the entire side perimetral surface of the first image reading device 42 may be, for example, more than 50% and less than 70%, or less than 50%.

If the outer member made of the recycled material and the outer member made of the non-recycled material are arranged discontinuously, for example, alternately in a region corresponding to the first region A1, many boundary lines between the recycled material and the non-recycled material exist complicatedly. In this case, the difference in color tone on both sides of the boundary line and the complicated boundary line tend to impair an aesthetic appearance of the multifunction device 11. The multifunction device 11 is configured as an assembly of N processing devices including the first processing device 30 and the second processing device 40. By separating the regions A1 and A2 of the first outer section 21 and the second outer section 22 for each of the first processing device 30 and the second processing device 40, the difference in color tone between the recycled material and the non-recycled material is made less noticeable.

Further, in the present embodiment, as in examples illustrated in FIGS. 3 to 6, the outer section 20 includes a third outer section 23 positioned between the first outer section 21 and the second outer section 22. In FIGS. 3 to 7, a dark dot region is the third outer section 23. The third outer section 23 is configured to have, for example, a continuous third region A3 as an appearance. If the first outer section 21 and the second outer section 22 are separated for each of the processing devices 30 and 40, the difference in color is less noticeable. However, if the first outer section 21 and the second outer section 22 separated for each of the processing devices 30 and 40 are adjacent to each other, the difference in color between both sides sandwiching a boundary between the first outer section 21 and the second outer section 22 is likely to be noticeable. The third outer section 23 is positioned between the first outer section 21 and the second outer section 22, and thus the first outer section 21 and the second outer section 22 are prevented from being adjacent to each other.

In examples illustrated in FIGS. 3 to 6, the device main body 12 includes the above-described third processing device 50 positioned between the first processing device 30 and the second processing device 40. The third outer section 23 may constitute at least a part of an appearance of the third processing device 50. In the examples illustrated in FIGS. 3 to 6, the third outer section 23 having the third region A3 indicated by the continuous dark dot region as an appearance constitutes at least a part of an appearance of the third processing device 50.

In the examples illustrated in FIGS. 3 to 6, the third processing device 50 may be at least one processing device positioned between the printing device 31, which is an example of the first processing device 30, and the first image reading device 42, which is an example of the second processing device 40. The number of the third processing devices 50 may be one or more. As illustrated in FIGS. 3 to 6, the third processing device 50 may include the stacking device 51. The third processing device 50 may include the second image reading device 43. The third processing device 50 may further include the operation device 55. In the examples illustrated in FIGS. 3 to 6, the third processing device 50 includes three processing devices, namely, the first image reading device 42, the stacking device 51, and the operation device 55.

### Color of First to Third Outer Sections

Next, the color of the outer section 20 will be described with reference to FIGS. 3 to 7. As illustrated in FIGS. 3 to 7, the first outer section 21 and the second outer section 22 have the first color. The third outer section 23 has the second color different from the first color. That is, in FIGS. 3 to 7, the first outer section 21 indicated by the white region and the second outer section 22 indicated by the light dot region both exhibit the first color. The first color is the light color, for example, white. The first outer section 21 is made of the recycled material, and the second outer section 22 is made of the non-recycled material. The first outer section 21 and the second outer section 22 have both the first color, but the color tone of the first outer section 21 and the color tone of the second outer section 22 are slightly different from each other depending on whether the materials of the first outer section 21 and the second outer section 22 are the recycled resin materials or the non-recycled resin materials. In particular, when the first color is a light color (for example, white) having a higher brightness than the intermediate color, the difference in color tone is more noticeable than the dark color or the intermediate color.

The second color has a lower brightness than the first color. The second color is the dark color. That is, the first color is the light color, whereas the second color is the dark color. The dark color is a color in a range from black to the intermediate color. The second color is, for example, black.

The white color of the first outer section 21 made of the recycled resin material is more likely to be yellowish than the white color of the second outer section 22 made of the non-recycled resin material, particularly in a dark place. When the recycled resin material is adopted for a part of the outer section 20, this kind of difference in color tone may cause deterioration of an aesthetic appearance of the multifunction device 11. In the present embodiment, the third outer section 23 that exhibits the second color different from the first color is positioned between the first outer section 21 and the second outer section 22, so that the difference in color tone is less likely to be visually recognized.

As illustrated in FIGS. 3 to 7, the third processing device 50 is interposed between the first processing device 30 and the second processing device 40, and thus the difference in color tone between the first processing device 30 and the second processing device 40 is made less noticeable.

As illustrated in FIGS. 3 to 7, portions on which the medium M1 and the medium M2 are placed or stacked have the second color. For example, the stacking table 52 of the stacking device 51, and the document tray 44B and the document stacker 44C of the first image reading device 42 exhibit the second color. The second color has a lower brightness than the first color, for example, is the dark color, and thus improves visibility when the medium M1 and medium M2, which generally exhibit white, are placed or stacked. The stacking table 52, the document tray 44B, and the document stacker 44C that do not constitute the third processing device 50 may have the dark color different from the second color. Here, the dark color is a color having a lower brightness than the intermediate color.

The third outer section 23 is constituted by one or more outer members forming the continuous third region A3 among one or more outer members made of the non-recycled material constituting the outer section 20.

The third outer section 23 is interposed between the first outer section 21 and the second outer section 22, thereby reducing the number of adjacent portions between the first outer section 21 and the second outer section 22. In the present embodiment, the third outer section 23 may be interposed between the first outer section 21 and the second outer section 22 to reduce the number of adjacent portions between the first outer section 21 and the second outer section 22 in each of the surfaces 20A to 20D of the multifunction device 11 viewed from the side.

As illustrated in FIGS. 3 to 6, the third outer section 23 may be provided on at least the front surface 20A among the four surfaces 20A to 20D when the multifunction device 11 is viewed from the side. The third outer section 23 may be provided for each of the four surfaces 20A to 20D of the multifunction device 11. The third outer section 23 on each of the four surfaces 20A to 20D may be continuous with the third outer section 23 positioned on the adjacent surface. The third outer section 23 may be continuous over a plurality of surfaces among the four surfaces 20A to 20D. The third outer section 23 may be continuous over all of the four surfaces 20A to 20D as in examples illustrated in FIGS. 3 to 6.

It is sufficient that, among the four surfaces 20A to 20D of the multifunction device 11, there is at least one surface where the third outer section 23 is interposed between the first outer section 21 and the second outer section 22. In this case, the third outer section 23 may be interposed between the first outer section 21 and the second outer section 22 at least at the front surface 20A among the four surfaces 20A to 20D of the multifunction device 11. Further, among the four surfaces 20A to 20D, there may be at least one surface where the third outer section 23 eliminates a boundary between the first outer section 21 and the second outer section 22. In particular, in examples illustrated in FIGS. 3 to 6, the third outer section 23 is present for each of the four surfaces 20A to 20D of the multifunction device 11. The third outer section 23 eliminates a boundary between the first outer section 21 and the second outer section 22 on all of the four surfaces 20A to 20D. The third outer section 23 may be continuous over the entire side perimetral surface of the multifunction device 11. The third outer section 23 may eliminate a boundary between the first outer section 21 and the second outer section 22 over the entire side perimetral surface of the multifunction device 11.

In examples illustrated in FIGS. 3 to 6, the third outer section 23 occupies 90% or more (100% as an example) of an outer area of the third processing device 50. The third outer section 23 may occupy 70% or more of the outer area of the third processing device 50, or may occupy more than half (50%) of the outer area of the third processing device 50. Further, the third outer section 23 may be configured to occupy at least a part of the outer area of the third processing device 50. For example, the third outer section 23 may be configured to occupy 50% or less of the outer area of the third processing device 50.

### Detailed Configuration of First to Third Processing Devices

Next, with reference to FIGS. 3 to 7, a description will be given of detailed configurations of the first to third processing devices in the multifunction device 11. Hereinafter, a configuration of each of the four surfaces 20A to 20D of the multifunction device 11 and a configuration of an upper surface will be described in order.

### Configuration of Front Surface 20A

First, a configuration of the front surface 20A of the multifunction device 11 illustrated in FIG. 3 will be described. The front surface 20A is a surface that faces the multifunction device 11 when a user operates the operation device 55. Therefore, the front surface 20A is a surface that is most easily visually recognized by the user among the four surfaces 20A to 20D. The multifunction device 11 includes the first image reading device 42, which is an example of the second processing device 40, above the printing device 31, which is an example of the first processing device 30. The third processing device 50 is provided at a position between the printing device 31 and the first image reading device 42. The third processing device 50 includes the second image reading device 43, the stacking device 51, and the operation device 55.

The outer section of each of the second image reading device 43, the stacking device 51, and the operation device 55 constitutes the third outer section 23 that exhibits the second color. The third outer section 23 exhibiting the second color is positioned between the first outer section 21 and the second outer section 22 each exhibiting the first color. The third outer section 23 is interposed between the first outer section 21 and the second outer section 22, and thus, a boundary at which the first outer section 21 and the second outer section 22 are adjacent to each other is eliminated.

The printing device 31 includes the plurality of (for example, four) first medium supply devices 36, the printing material supply device 60, the transport device 14 illustrated in FIG. 2 covered by the main body cover 62, and the print processing device 15. The multifunction device 11 includes a plurality of casters 28 on a bottom section.

In the front surface 20A illustrated in FIG. 3, the first outer section 21 having the continuous first region A1 as an appearance constitutes at least a part of an appearance of the printing device 31. The first outer section 21 includes a plurality of (for example, four) front wall sections 38B of cassettes 38, the main body cover 62, the printing material cover 61, and a side edge section 63. The main body cover 62 is arranged on an upper side of the plurality of cassettes 38, and the printing material cover 61 is arranged on an upper side of the main body cover 62. A back surface of the cassette 38 exposed to the handle section 38A is made of the non-recycled material.

The first image reading device 42 positioned on an upper side of the image reading device 41 arranged on an upper side of the printing device 31 corresponds to an example of the second processing device 40. The second outer section 22 of which the second region A2 constitutes an appearance is constituted by a housing of the first image reading device 42. The housing of the first image reading device 42 is a housing of the ADF device 44. That is, the second outer section 22 is constituted by the housing of the ADF device 44. The housing of the first image reading device 42 (ADF device 44) constitutes the second outer section 22 having the continuous second region A2 as an appearance. The housing of the first image reading device 42 is made of the non-recycled material. The first image reading device 42 also serves as the cover 44A that is opened and closed with respect to the document table 45 of the second image reading device 43. The first image reading device 42 includes the document tray 44B and the document stacker 44C. The document tray 44B and the document stacker 44C may exhibit the second color (for example, black).

The stacking device 51 is arranged at a position above the main body cover 62 and on the right of the printing material cover 61. The stacking device 51 includes the medium discharge space MA to which the medium M1 after printing is discharged. The stacking device 51 includes the stacking table 52 that constitutes the bottom section of the medium discharge space MA, the discharge plate section 53 that includes a surface parallel to the vertical direction Z in which a discharge port (not illustrated) of the medium M1 is open, and the back plate section 54 that forms a back surface of the medium discharge space MA. The operation device 55 is arranged on an upper side of the printing material cover 61. The operation device 55 is arranged at substantially the same height as the second image reading device 43, and is arranged at a position on a front side (+X direction side) in the depth direction X with respect to the second image reading device 43.

The first cassette 38 from the top among the four cassettes 38 has a width dimension, which is a dimension in the width direction Y of the front wall section 38B, shorter than width dimensions of the front wall sections 38B of the second to fourth cassettes 38. Therefore, the side edge section 63 is exposed in a left adjacent portion of the first stage cassette 38. The side edge section 63 constitutes a part of the first outer section 21. The side edge sections 64 are arranged on a lower side of the side edge section 63. The side edge sections 63 and 64 are positioned at corner sections of the printing device 31 having a substantially rectangular parallelepiped shape. The side edge sections 64 are covered with left end sections of the second to fourth cassettes 38 in front view illustrated in FIG. 3. When at least one of the second to fourth cassettes 38 is pulled out from the device main body 12, a part of the side edge sections 64 that was covered by the cassette 38 is exposed.

In this manner, members such as the side edge sections 64 that are visibly exposed when a user performs an operation such as pulling out may also constitute a part of the outer section 20. A tray storage member (not illustrated) including a tray storage surface that is exposed to be visible when a user opens the trays 39 and 83 may also constitute a part of the outer section 20. Further, a transport path member (not illustrated) that is exposed to be visible to a user when the main body cover 62 and the maintenance covers 65 to 67 and 84 are opened may also constitute a part of the outer section 20.

The liquid cartridges IC, which are examples of the liquid supply source, are accommodated inside the printing material cover 61 of the printing material supply device 60 illustrated in FIG. 3. In an example illustrated in FIG. 3, a plurality of liquid cartridges IC are accommodated inside the printing material cover 61. For example, the liquid cartridge IC may accommodate inks of a plurality of colors including four colors of black, cyan, magenta, and yellow. The liquid cartridge IC that accommodates black ink may have a larger ink capacity than the liquid cartridge IC that accommodates ink for color printing. A plurality of liquid cartridges IC that accommodate black ink may be mounted inside the printing material cover 61. The cover 61 may have the window section 61A through which an ink remaining amount in the liquid cartridge IC accommodated can be visually checked.

### Configuration of Right Side Surface 20B

Next, a configuration of the right side surface 20B of the multifunction device 11 illustrated in FIG. 4 will be described. The right side surface 20B is a surface that is visually recognized when a user sets the medium M1 on the feed tray 39. Therefore, the right side surface 20B is a surface that is the second most easily visually recognized by the user next to the front surface 20A.

As illustrated in FIG. 4, the second image reading device 43, the stacking device 51, and the operation device 55, which are examples of the third processing device 50, are positioned at positions between the first image reading device 42 and the printing device 31. The third outer section 23 exhibiting the second color is positioned between the first outer section 21 and the second outer section 22 each exhibiting the first color. The third outer section 23 is interposed between the first outer section 21 and the second outer section 22 over the entire region in the depth direction X. Therefore, there is no boundary where the first outer section 21 and the second outer section 22 are adjacent to each other.

In the right side surface 20B illustrated in FIG. 4, the first outer section 21 having the continuous first region A1 (white region) as an appearance constitutes an appearance of the printing device 31. The first outer section 21 made of the recycled material includes the feed tray 39, the maintenance covers 65 to 67, panels 68A, 68B, 69A, and 69B, and an interface device 80. The feed tray 39 and the maintenance covers 65 to 67 are arranged in this order from above on a lower side of the stacking device 51. On a right side of the feed tray 39 and the maintenance covers 65 to 67, the panels 68A and 68B are arranged vertically. The interface device 80 is provided on a right side of the lower panel 68B.

The interface device 80 includes one or more communication connector sections 81 and a power supply connector section 82. In an example illustrated in FIG. 4, the interface device 80 includes a plurality of (for example, four) communication connector sections 81. The interface device 80 includes a housing 80A. The communication connector section 81 mounted in the housing 80A includes a connector and a cover part that supports the connector in a state of covering the periphery of the connector. The cover part is made of the non-recycled material (general material). The cover part is used in the second device 110 (second multifunction device 111) described later or other models, and a recycled material status of an outer section is different in each model. When the cover part of the communication connector section 81 is made of the recycled material, there is a possibility that an appearance of other models may be affected. For parts applied to a plurality of models, handling such as management is easier when the general materials are used. Therefore, the cover part is not a target to be recycled.

The feed tray 39 includes an opening and closing lever 39A. The opening and closing lever 39A has a function of locking the feed tray 39 in a closed state illustrated in FIG. 4 and a function of releasing the locking by an opening operation of a user. The first maintenance cover 65 includes an opening and closing lever 65A. The first maintenance cover 65 is opened when a jam of the medium M1 fed from the feed tray 39 and the cassette 38 is to be cleared. When the first maintenance cover 65 is opened, a path forming member (not illustrated) that forms the first feed path T1 and the second feed path T2 (both see FIG. 2) is exposed. The opening and closing lever 65A has a function of locking the first maintenance cover 65 in a closed state illustrated in FIG. 4 and a function of releasing the locking by an opening operation of a user.

The maintenance cover 66 includes the supply port 66A through which the medium M1 can be supplied from an outside, and an opening and closing lever 66B. The maintenance cover 67 includes an opening and closing lever 67A. The maintenance covers 66 and 67 are opened when a jam of the medium M1 fed from the cassette 38 is to be cleared. When the maintenance covers 66 and 67 are opened, a path forming member (not illustrated) that forms the first feed path T1 (see FIG. 2) is exposed. The opening and closing levers 66B and 67A have a function of locking the maintenance covers 66 and 67 in a closed state illustrated in FIG. 4 and a function of releasing the locking by an opening operation of a user.

In the right side surface 20B, the panel 69A having a vertically long shape is positioned at a position adjacent to the left of the first maintenance cover 65. The panel 69B having a vertically long shape is positioned at positions adjacent to the left of the maintenance covers 66 and 67. The two panels 69A and 69B are arranged one above the other and form a support column section. At end section positions to the left of the upper and lower panels 69A and 69B, the main body cover 62 on a front surface 20A side and right side surfaces of the four cassettes 38 are visible. The first region A1 of the right side surface 20B is continuous with the first region A1 on a front surface 20A side.

As illustrated in FIG. 4, the outer section 20 of the multifunction device 11 may include a fourth outer section 24. The fourth outer section 24 is a region indicated by light dots and hatching in FIG. 4. In an example illustrated in FIG. 4, the fourth outer section 24 is the opening and closing levers 39A, 65A, 66B, and 67A. The fourth outer section 24 exhibits a third color.

The third color is different from the first color exhibited by the first outer section 21 and the second outer section 22. The third color is different from the second color exhibited by the third outer section 23. The third color is, for example, gray. The third color is a color different from white, which is an example of the first color, and is also a color different from black, which is an example of the second color. The third color may be a color having a lower brightness than the first color and a higher brightness than the second color. The third color may be the intermediate color. The third color may be a color other than gray as long as the color is different from the first color.

The fourth outer section 24 may not include the recycled resin material. That is, the fourth outer section 24 is made of the non-recycled material (general material). Lever parts constituting the opening and closing levers 39A, 65A, 66B, and 67A have gray in color, which is different from the color of the other outer sections 21, 22, and 23. Since the lever part originally has a color different from that of the first outer section 21 arranged adjacent thereto, the difference in color is not noticeable even when the lever part is adjacent to the first outer section 21 exhibiting the first color (for example, white). When the number of types of colors of the recycled material increases, it takes time and effort to perform color matching. Furthermore, the lever parts are small and therefore do not have a significant impact on the recycled material usage rate. For these reasons, the lever parts are not made of recycled material.

### Configuration of Left Side Surface 20C

Next, a configuration of the left side surface 20C of the multifunction device 11 illustrated in FIG. 5 will be described. The left side surface 20C is a surface that is visually recognized when a user collects the printed medium M1 discharged to the discharge tray 83. Therefore, the left side surface 20C is a surface that is the second most easily visually recognized next to the front surface 20A, similarly to the right side surface 20B.

In the left side surface 20C illustrated in FIG. 5, the second image reading device 43 and the operation device 55, which are examples of the third processing device 50, are positioned at a position between the first image reading device 42 and the printing device 31. In the left side surface 20C, the first outer section 21 having the continuous first region A1 (white region) as an appearance constitutes an appearance of the printing device 31. The second outer section 22 having the continuous second region A2 (light dot region) as an appearance constitutes an appearance of the first image reading device 42. The third outer section 23 exhibiting the second color is positioned between the first outer section 21 exhibiting the first color and the second outer section 22 exhibiting the first color. The third outer section 23 is interposed at a position between the first outer section 21 and the second outer section 22 over the entire region in the depth direction X. Therefore, there is no boundary where the first outer section 21 and the second outer section 22 are adjacent to each other.

The first outer section 21 made of the recycled material includes the discharge tray 83, the maintenance cover 84, and panels 85 to 87. The discharge tray 83 includes an opening and closing lever 83A. The opening and closing lever 83A has a function of locking the discharge tray 83 in a closed state illustrated in FIG. 5 and a function of releasing the locking by an opening operation of a user. The discharge tray 83 is opened and closed by, for example, pivoting about a lower end section thereof.

The maintenance cover 84 includes an opening and closing lever 84A. The opening and closing lever 84A has a function of locking the maintenance cover 84 in a closed state illustrated in FIG. 5 and a function of releasing the locking by an opening operation of a user. The maintenance cover 84 may be opened and closed by sliding in the width direction Y, for example. The maintenance cover 84 is opened by a user when a jam of the printed medium M1 on the second discharge path T7 (see FIG. 2) is to be cleared. When the maintenance cover 84 is opened, a part of a path forming member (not illustrated) that forms the second discharge path T7 is exposed.

The panels 85 to 87 form the left side surface 20C in a region other than the maintenance cover 84. The upper panel 85 is an outer part made of a square annular plate material surrounding the maintenance cover 84. The rear panel 86 is arranged on the left of the panel 85. The lower panel 87 is arranged adjacent to a lower side of the two upper panels 85 and 86. The lower panel 87 includes a pocket 87A attached thereto. At end section positions to the right of the upper and lower panels 85 and 87, left side surfaces of the covers 61 and 62 and the side edge sections 63 and 64 on a front surface 20A side are visible. The first region A1 of the left side surface 20C is continuous with the first region A1 on a front surface 20A side.

### Configuration of Rear Surface 20D

Next, a configuration of the rear surface 20D of the multifunction device 11 illustrated in FIG. 6 will be described. The rear surface 20D is a surface that is less frequently visually recognized by a user. In the rear surface 20D illustrated in FIG. 6, the second image reading device 43, which is an example of the third processing device 50, is arranged at a position between the first image reading device 42 and the printing device 31. In the rear surface 20D, the first outer section 21 having the continuous first region A1 (white region) as an appearance constitutes an appearance of the printing device 31. The second outer section 22 having the continuous second region A2 (light dot region) as an appearance constitutes an appearance of the first image reading device 42. The third outer section 23 exhibiting the second color is positioned between the first outer section 21 exhibiting the first color and the second outer section 22 exhibiting the first color. The third outer section 23 constitutes an appearance of the second image reading device 43. The third outer section 23 is interposed at a position between the first outer section 21 and the second outer section 22 over the entire region in the width direction Y. Therefore, there is no boundary where the first outer section 21 and the second outer section 22 are adjacent to each other.

The first outer section 21 made of the recycled material includes panels 86, 88, 90, and 91. The rear panel 86 is positioned on an upper right side of the rear surface 20D. The rear panel 86 is an outer part that extends from the left side surface 20C and has an L-shaped cross-section when viewed from above. The upper panel 88 is positioned to the left of the rear panel 86. The lower panel 90 is arranged adjacent to a lower side of the two upper panels 86 and 88. The panel 90 includes ventilation sections 90A including ventilation holes. The ventilation section 90A is used as, for example, an air intake port or an air exhaust port for air for cooling or cleaning an inside of the device main body 12. The lower panel 91 is arranged on the left of the panel 90. The interface device 80 is arranged so as to cover a part of the lower panel 91 in rear view illustrated in FIG. 6.

In the rear surface 20D, at end section positions to the left of the upper and lower panels 88 and 91, right side surfaces of the panels 68A and 68B on a right side surface 20B side are visible. The first region A1 of the rear surface 20D is continuous with the first region A1 on a right side surface 20B side. A right end section of the upper rear panel 86 extends toward the left side surface 20C. A left side surface of the panel 87 on a left side surface 20C side is visible at an end section position to the left of the lower panel 90. The first region A1 of the rear surface 20D is continuous with the first region A1 on a left side surface 20C side.

### Configuration of Upper Surface of Multifunction Device 11

As illustrated in FIG. 7, on an upper surface of the multifunction device 11, the second outer section 22 made of the non-recycled material and having the second region A2 as an appearance is positioned on a left back side (upper left in FIG. 7), and the third outer section 23 made of the recycled material and having the third region A3 as an appearance is positioned on a right front side (lower right in FIG. 7). In top view, the document tray 44B and the third outer section 23 both exhibiting the second color partially overlap each other. In top view, the region is separated into the second region A2 that exhibits the first color on an upper left side and a region that exhibits the second color on a lower right side. On the upper surface of the multifunction device 11, a region of the recycled material is quite small, and therefore the adjacent portion between the region of the recycled material and a region of the non-recycled material is quite small. In FIG. 7, a screen of the display device 57 is illustrated by a white region, but is not a part of the outer section 20, and is not made of the recycled material.

### Configuration of Cassette 38

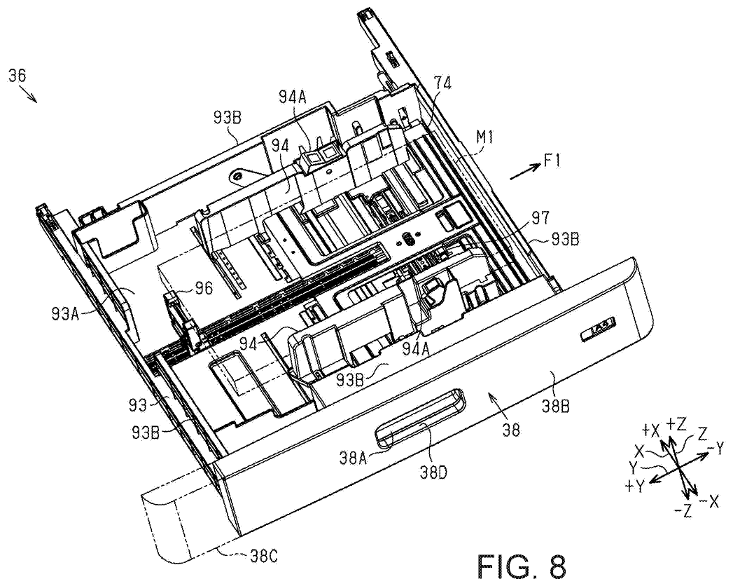

Next, a configuration of the cassette 38 will be described with reference to FIG. 8. The cassette 38 includes the front wall section 38B and the accommodation section 93 for accommodating the medium M1. The accommodation section 93 includes a placement section 93A formed of a bottom wall and side walls 93B. FIG. 8 illustrates the first cassette 38 of the multifunction device 11. The second to fourth cassettes 38 each have an extension section 38C indicated by a two dot chain line in FIG. 8 in which the front wall section 38B extends in the +Y direction. The extension section 38C is arranged to cover the side edge section 64 positioned at the corner section of the multifunction device 11 in an inserted state of the cassette 38 (see FIG. 3). The handle section 38A of the cassette 38 illustrated in FIG. 8 is constituted by a hole section 38D formed in the front wall section 38B and a surface of the accommodation section 93 positioned on a back side of the hole section 38D. The front wall section 38B is exposed to an outside in a state of being inserted into the device main body 12. That is, the front wall section 38B constitutes a part of the outer section 20. A user can pull out the cassette 38 by hooking a hand on the handle section 38A. The handle section 38A is not limited to being provided at a substantially central position of the front wall section 38B in the vertical direction Z, and may be provided at an upper end position or a lower end position of the front wall section 38B.

The accommodation section 93 is a portion with which the medium M1 accommodated in a stacked state contacts. When the material of the accommodation section 93 is changed from the non-recycled resin material to the recycled resin material, the characteristics such as the frictional resistance of the accommodation section 93 with respect to the medium M1, the performance, and the like may change. When there is a possibility that the characteristics, the performance, and the like of the accommodation section 93 change, it is necessary to reevaluate the characteristics, the performance, and the like of the accommodation section 93 whose material was changed to the recycled resin material. This type of re-evaluation is time consuming and may require various adjustments to clear the predetermined reference. Therefore, in the present embodiment, the material of the accommodation section 93 of the cassette 38 is left as the non-recycled resin material.

As illustrated in FIG. 8, the cassette 38 includes a hopper 74. The hopper 74 is biased upward (in the +Z direction) by the spring 73 (see FIG. 2) in a state where the hopper 74 is tiltable with respect to the placement section 93A. The hopper 74 is stored in a horizontal state in a state where the cassette 38 is pulled out from the device main body 12, and is biased upward in a state where the cassette 38 is inserted into the device main body 12. The hopper 74 lifts at least a part of the medium M1 placed on the placement section 93A, thereby bringing the medium M1 closer to the feed roller 71.

The cassette 38 includes edge guides 94 and 96. The cassette 38 may include a plurality of edge guides 94 and 96. The edge guides 94 and 96 aligns edges of the medium M1 placed on the placement section 93A. The cassette 38 of the present embodiment includes a pair of first edge guides 94 and one second edge guide 96. The first edge guides 94 and the second edge guide 96 may align different edges of the medium M1.

The pair of first edge guides 94 guide both side edges of the medium M1 in the medium width direction X. The pair of first edge guides 94 are provided so as to be movable in the medium width direction X with respect to the placement section 93A. A user adjusts positions of the pair of first edge guides 94 in the medium width direction X to position the position of the medium M1 placed on the placement section 93A in the medium width direction X. The first edge guide 94 includes an operation section 94A that is operated by the user. The operation section 94A is operated to an operating position at which the movement of the first edge guides 94 are allowed and a locking position at which the movement of the first edge guides 94 are not allowed. The cassette 38 includes an interlocking mechanism 97. The interlocking mechanism 97 is a mechanism that interlocks movement directions of the pair of first edge guides 94. The interlocking mechanism 97 interlocks movement directions of the pair of first edge guides 94 in a direction in which the first edge guides 94 approach each other or a direction in which the first edge guides 94 are separated from each other.

The second edge guide 96 guides a trailing edge of the medium M1, which is an upstream edge of the medium M1 in the transport direction F1 (feed direction). The second edge guide 96 is provided so as to be movable in the transport direction F1 with respect to the placement section 93A. The user adjusts a position of the second edge guide 96 in the transport direction F1 to position the position of the medium M1 placed on the placement section 93A in the transport direction F1.

### Resin Part 95

Next, a resin part 95 will be described with reference to FIGS. 3 to 8. The device main body 12 may include the resin part 95. The resin part 95 may be a part related to transport of the medium M1. The resin part 95 may be a component part of the cassette 38. The resin part 95 may be a resin part related to transport of the medium M1 in the cassette 38. The resin part 95 does not contain the recycled resin material. That is, the resin part 95 is made of the non-recycled material (general material). The resin part 95, which may affect a function due to the strength, the expansion rate, or the like, among resin parts constituting the device main body 12, is not made of the recycled material but is made of the non-recycled material, thereby preventing the deterioration of the function.

In general, the medium M1 is required to be transported with high accuracy. For example, the accuracy of transport of the medium M1 is required to be high enough to prevent multi-feeding, non-feeding, skew, transport timing deviation, and the like of the medium M1 to a predetermined level or less. Therefore, by using the non-recycled material as the resin part 95 related to transport, the deterioration of the function related to transport is prevented.

A back wall of the handle section 38A provided on the front wall section 38B of the cassette 38 is where a part of the accommodation section 93 is visible, and is related to the medium feeding performance. In a case where the accommodation section 93 is changed to the recycled material, it is necessary to reevaluate whether or not the same medium feeding performance as that of the non-recycled material (general material) can be secured. Therefore, the recycled material is not adopted for the accommodation section 93.

In the present embodiment, the accommodation section 93 of the cassette 38 corresponds to the resin part 95. The accommodation section 93 is made of the non-recycled material, thereby maintaining the characteristics such as the frictional resistance of the placement section 93A with respect to the medium M1, the performance, and the like.

The resin part 95 may be a part other than the accommodation section 93 of the cassette 38. The resin part 95 may be the transport path member, a holding section of a roller shaft, the edge guides 39E, 44E, 94, and 96, the feed tray 39, or the like. At least one of the edge guides 39E, 44E, 94, and 96 may be the resin part 95 made of the non-recycled material.

The transport path member is a guide member that guides the medium M1 along the transport path T. For example, when the main body cover 62 and the maintenance cover 65, 66, 67, and 84 are opened, the transport path members positioned at positions corresponding to the covers 62, 65, 66, 67, 84 are exposed. At least one of these transport path members may be the resin part 95 made of the non-recycled material.

The holding section of the roller shaft is a member that rotatably holds a roller shaft that is a shaft of the roller 71 and 79A, and the roller pairs 72 and 75 to 78. At least one of the holding sections that hold the roller shafts may be the resin part 95 made of the non-recycled material. At least one of the holding sections that hold roller shafts of rollers (not illustrated) constituting the transport device 14 may be the resin part 95 made of the non-recycled material. The holding section may be a part of the transport path member.

The feed tray 39 is a placement section on which the medium M1 to be fed are placed in the second medium supply device 37. The feed tray 39 may be the resin part 95 by being made of the non-recycled material (general material) that is a member made of the non-recycled resin material.

### Configuration of Second Device 110

Next, a configuration of the second device 110 will be described with reference to FIGS. 9 to 14. In order to distinguish from the second device 110, the device 10 illustrated in FIGS. 1 to 7 is referred to as a first device 10. The second device 110 is a model similar to the first device 10. A basic internal configuration of the second device 110 is the same as an internal configuration of the first device 10 illustrated in FIG. 2. Therefore, an internal configuration of the second device 110 is substituted by FIG. 2, and the illustration and description of the internal configuration are omitted. The second device 110 is a multifunction device 111 of a different model from the multifunction device 11, which is an example of the first device 10. In order to distinguish from the multifunction device 11 illustrated in FIGS. 1 to 7, the multifunction device 11 illustrated in FIGS. 1 to 7 is referred to as a “first multifunction device 11”, and the multifunction device 111 illustrated in FIGS. 9 to 14 is referred to as a “second multifunction device 111”.

The first device 10 may be, for example, an improved model or a similar model of the second device 110. The second device 110 may be an improved model of the first device 10. The second device 110 may be an old model, and the first device 10 may be a new model that is a successor of the second device 110. The first device 10 may be a different model in which some of outer parts of the second device 110 are common parts.

FIG. 9 is a perspective view of the second multifunction device 111, which is an example of the second device 110. The second multifunction device 111 is different in model from the first multifunction device 11. A part of an outer section of the first multifunction device 11 and a part of an outer section of the second multifunction device 111 are used for each other.

The first multifunction device 11 and the second multifunction device 111 include the same basic configuration of device main bodies 12 and 112 and the like. The second multifunction device 111 includes a first processing device 130, a second processing device 140, and a third processing device 150. The first processing device 130, the second processing device 140, and the third processing device 150 include basically the same configurations as the first processing device 30, the second processing device 40, and the third processing device 50 included in the first multifunction device 11. Among the devices, members, and the like that are the constituent elements of the first processing device 130, the second processing device 140, and the third processing device 150, the same reference symbols as those of the first multifunction device 11 are given to the same configurations as those of the first multifunction device 11, and the detailed description thereof will be omitted. Hereinafter, the second multifunction device 111 will be described mainly focusing on a configuration different from that of the first multifunction device 11.

The second multifunction device 111 includes, as an example of the first processing device 130, the printing device 31 similar to that of the first multifunction device 11. The second multifunction device 111 includes, as an example of the second processing device 140, the image reading device 41 similar to that of the first multifunction device 11. The image reading device 41 includes the first image reading device 42 and the second image reading device 43. In the second multifunction device 111, the entire image reading device 41 is an example of the second processing device 140. The second multifunction device 111 includes the stacking device 51 and the operation device 55 similar to those of the first multifunction device 11 as an example of the third processing device 150. The second multifunction device 111 includes the printing device 31, the first image reading device 42, the second image reading device 43, the stacking device 51, and the operation device 55, similarly to the first multifunction device 11. The printing device 31, the first image reading device 42, the second image reading device 43, the stacking device 51, and the operation device 55 of the first multifunction device 11 may be partially different from those of the second multifunction device 111 in the material, shape, size, layout, or the like of each component member.

The second multifunction device 111 includes the control section 100 at a predetermined position in the device main body 112. The control section 100 controls the printing device 31, the image reading device 41, the operation device 55, and the like. The control section 100 receives input information from the operation section 56 of the operation device 55.

### Outer Structure of Second Device 110

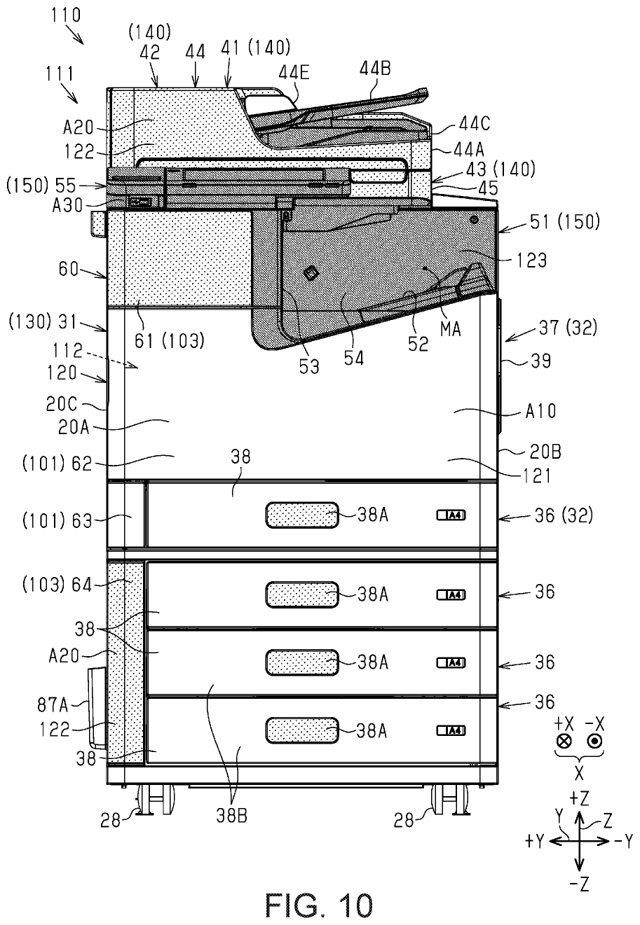

Next, an outer structure of the second multifunction device 111, which is an example of the second device 110, will be described with reference to FIGS. 10 to 14. In FIGS. 10 to 14, a region of the recycled material is indicated by the white region, and a region of the non-recycled material is indicated by the light dot region, as in FIGS. 3 to 7. A region of the second color, which is a color different from the first color that is a color of the region of the recycled material and the region of the non-recycled material, is indicated by the dark dot region.

The second device 110 includes the device main body 112 and an outer section 120. The outer section 120 is attached to an outside of the device main body 112 and constitutes an appearance of the second device 110. The outer section 120 includes a first outer section 121 that constitutes an appearance of a continuous first region A10 and a second outer section 122 that constitutes an appearance of a continuous second region A20. The first outer section 121 contains the recycled resin material. The second outer section 122 does not contain the recycled resin material. That is, the first outer section 121 is made of the recycled material, and the second outer section 122 is made of the non-recycled material (general material).

The device main body 112 includes the first processing device 130 that performs the first process and the second processing device 140 that performs the second process. The first outer section 121 constitutes at least a part of an appearance of the first processing device 130. The second outer section 122 constitutes at least a part of an appearance of the second processing device 140.

The first processing device 130 is the printing device 31 that executes printing on the medium M1 as the first process. The printing device 31 includes the medium supply device 32, the transport device 14 (see FIG. 2), and the print processing device 15. The medium supply device 32 includes the first medium supply device 36 and the second medium supply device 37. The first medium supply device 36 includes cassettes 38. The cassette 38 includes the handle section 38A. A part of the accommodation section 93 constituting the cassette 38 is exposed on a back surface of the handle section 38A. The accommodation section 93 is the resin part 95 related to transport.

The second processing device 140 is the image reading device 41 that reads an image on the medium M2 as the second process. The image reading device 41 includes the sheet feed type first image reading device 42 and the flatbed type second image reading device 43. In the second multifunction device 111, the second image reading device 43 belongs to the second processing device 140. That is, the outer section of the second image reading device 43 is made of the non-recycled material (general material) that does not contain the recycled resin material.

The first image reading device 42 includes the ADF device 44. The ADF device 44 may include the document cover 44A, the document tray 44B, the document stacker 44C, the maintenance cover 44D, the edge guides 44E, and the opening and closing lever 44F. The second image reading device 43 includes the document table 45. The document cover 44A can be opened and closed together with the ADF device 44 with respect to the document table 45. In an opened state of the document cover 44A, a placement surface (not illustrated) made of a glass plate is exposed on an upper surface of the document table 45. A user can read an image of the medium M2 such as a document using the sheet feed type first image reading device 42, and can also read an image of the medium M2 such as a document placed on the document table 45 using the flatbed type second image reading device 43. The document tray 44B and the document stacker 44C exhibit the second color.

The second multifunction device 111 includes the third processing device 150 positioned between the first processing device 130 and the second processing device 140. The third processing device 150 includes the stacking device 51 and the operation device 55. The operation device 55 may include the operation section 56 operated by a user. The operation device 55 may include the display device 57. The display device 57 may include a touch panel for touching a screen. The operation section 56 may be a touch panel operation section or a mechanical switch.

In the front surface 20A of the second multifunction device 111 illustrated in FIG. 10, a third region A30 is positioned between the first region A10 and the second region A20. The first region A10 is a region of the recycled material, and the color thereof is the first color. The second region A20 is a region of the non-recycled material (general material), and the color thereof is the first color. The color of the third region A30 is the second color. The first color is, for example, white. The second color is, for example, black. In the front surface 20A illustrated in FIG. 10, the third region A30 exhibiting the second color (for example, black) is positioned between the first region A10 and the second region A20 exhibiting the first color (for example, white), and thus, even when there is a difference in color tone between the first colors of the two regions A10 and A20, the difference in color tone is less likely to be noticeable.

The printing device 31 includes the printing material cover 61, the main body cover 62, the plurality of cassettes 38, and the side edge sections 63 and 64 on the front surface 20A illustrated in FIG. 10. The printing material cover 61 and the side edge section 64 are made of the non-recycled material (general material) that does not contain the recycled resin material. The printing material cover 61 of the second multifunction device 111 does not include the window section 61A of the printing material cover 61 of the first multifunction device 11. The second multifunction device 111 has a substantially rectangular parallelepiped shape. The side edge sections 63 and 64 are positioned at corner sections of the second multifunction device 111. The side edge section 64 of the second multifunction device 111 has a shape different from that of the side edge section 64 of the first multifunction device 11. The side edge section 64 of the first multifunction device 11 is covered with the left end section of the cassette 38, whereas the side edge section 64 of the second multifunction device 111 is not covered with the cassette 38. The side edge section 64 of the second multifunction device 111 is exposed to a left adjacent portion of the cassette 38.

The printing material cover 61 adjacent to a lower side of the operation device 55 is made of the non-recycled material (general material). The printing material cover 61 is positioned in an upper section of the printing device 31 near the second region A20, which is above the first region A10. If the printing material cover 61 exhibiting the first color is sandwiched from above and below by two members made of the recycled material exhibiting the first color, the difference in color tone of the printing material cover 61 is relatively noticeable. In contrast, in an example illustrated in FIG. 10, an upper region including the second outer section 122 and the printing material cover 61 in the second multifunction device 111 is a region made of the non-recycled material sandwiching a third outer section 123 exhibiting the second color. That is, only the third outer section 123 exhibiting the second color is interposed between the printing material cover 61 and the second outer section 122, and a region made of the recycled material exhibiting the first color is not interposed. On the front surface 20A, the printing material cover 61 is adjacent to the first outer section 121 only on an underside. Therefore, even if the printing material cover 61 is made of the non-recycled material, the difference in color tone is relatively less noticeable.

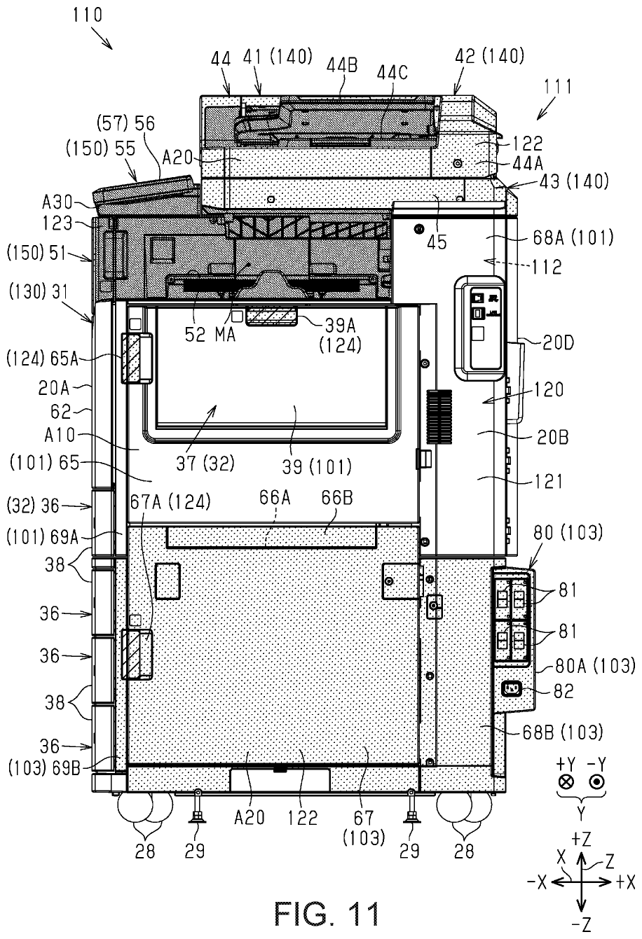

The printing device 31 includes, on the right side surface 20B illustrated in FIG. 11, the feed tray 39, the maintenance covers 65 and 67, panels 68A, 68B, 69A, and 69B, and the interface device 80. The maintenance cover 67, the panels 68B and 69B, and the interface device 80, which are positioned in a lower section of the right side surface 20B, are made of the non-recycled material that does not contain the recycled resin material. The opening and closing lever 39A, 65A, and 67A constitute a fourth outer section 124 similar to the fourth outer section 24 of the first multifunction device 11.

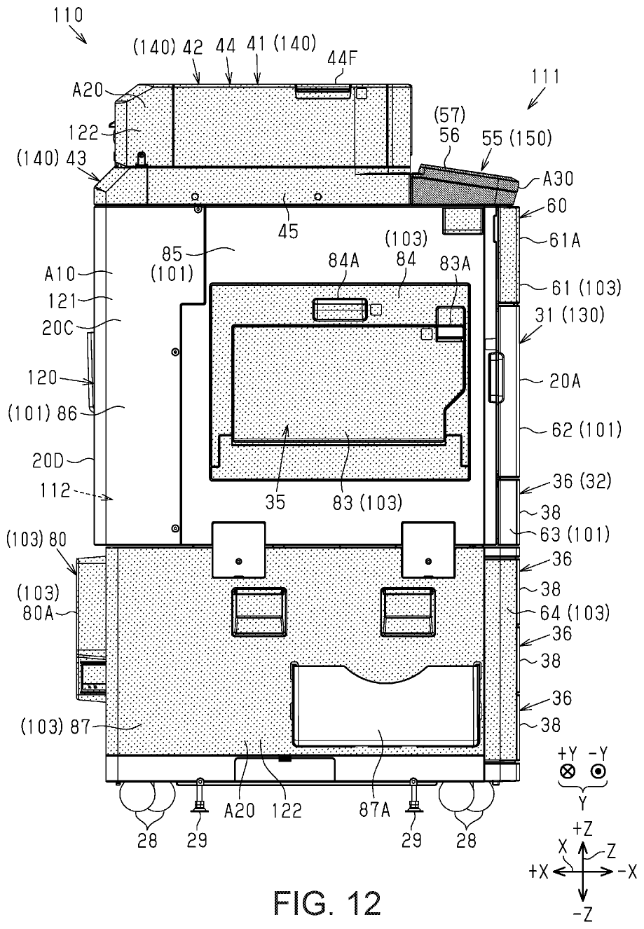

The printing device 31 includes the discharge tray 83, the maintenance cover 84, and the panels 85 to 87 on the left side surface 20C illustrated in FIG. 12. The discharge tray 83 and the maintenance cover 84 positioned at an upper section of the left side surface 20C are made of the non-recycled material (general material) that does not contain the recycled resin material. The panel 87 positioned at a lower section of the left side surface 20C is made of the non-recycled material (general material) not containing the recycled resin material.

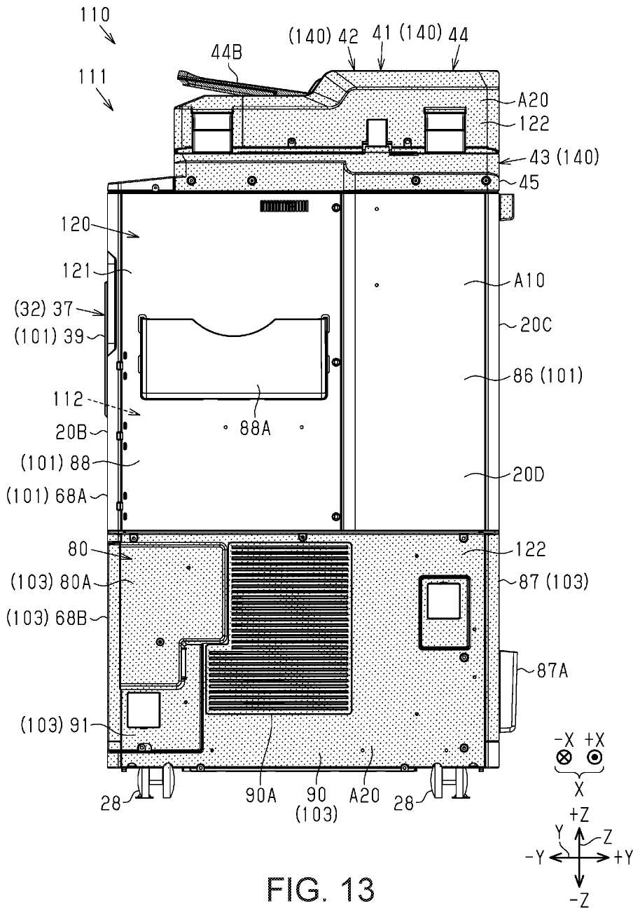

The printing device 31 includes the rear panel 86 and the panels 88, 90, and 91 on the rear surface 20D illustrated in FIG. 13. The panels 90 and 91 positioned at a lower section of the rear surface 20D is made of the non-recycled material (general material) not containing the recycled resin material.

### Outer Parts in First Multifunction Device 11 and Second Multifunction Device 111

Next, outer parts in the first multifunction device 11 and the second multifunction device 111 will be described with reference to FIGS. 3 to 7 and 10 to 14.

As illustrated in FIGS. 3 to 6, the first multifunction device 11 includes the first outer section 21 containing the recycled resin material as described above. The first outer section 21 includes a first outer part 101 and a second outer part 102. Both the first outer part 101 and the second outer part 102 contain the recycled resin material. That is, both the first outer part 101 and the second outer part 102 are parts made of the recycled material. In FIGS. 3 to 7, reference numerals of the first outer part 101 and the second outer part 102 are illustrated in parentheses ().

As illustrated in FIG. 3, the front surface 20A, which is an example of a first surface of the first multifunction device 11, may be formed by the first outer part 101 and the second outer part 102. That is, the four cassettes 38, the main body cover 62, and the side edge section 63 appear as the first outer part 101, and the printing material cover 61 appears as the second outer part 102 on the front surface 20A of the printing device 31. In a state where the cassette 38 is pulled out from the device main body 12, a part of the side edge section 64 covered with the cassette 38 appears. The front surface 20A of the printing device 31 is made of the recycled material over almost the entire region except the resin parts 95 forming the back surfaces of the handle sections 38A of the cassettes 38. The handle section 38A may also be made of the recycled material.

The first outer part 101 can be mounted on the second multifunction device 111. That is, the first outer part 101 containing the recycled resin material that constitutes a part of an appearance of the continuous first region A1 in the first multifunction device 11 can be mounted on the second multifunction device 111. That is, the first outer part 101 is a part common to the first multifunction device 11 and the second multifunction device 111. The first outer part 101 is also used to the second multifunction device 111. The first outer part 101 may be a part constituting at least a part of the first outer section 21 of the first multifunction device 11.

Here, although the configuration of the related art described in JP-A-2016-156991 can prevent the assembly of two types of outer parts in a wrong combination, the determination cannot be made unless the internal appearance shape is confirmed. Therefore, even if an inappropriate outer part is mixed in a process of management, it is difficult to notice the mixing until the time of assembly. It is desirable that outer parts having the same appearance shape are common parts in the two devices 10,110, but there is a demand for preventing an aesthetic appearance from being impaired.

Outer parts of the first multifunction device 11 include the first outer part 101 that is a common part with the second multifunction device 111 and the second outer part 102 that is not a common part. For example, if the first multifunction device 11 can be made of the recycled material and the second multifunction device 111 can be made of the non-recycled material, then the second multifunction device 111 is not be affected by the first multifunction device 11 being made of the recycled material. However, when the recycled material and the non-recycled material are produced using the same mold, it is difficult to distinguish between them by color or appearance, and there is a possibility of confusing the two. When the common part is manufactured separately as the recycled material and the non-recycled material, productivity is reduced due to extra work accompanying replacement of a raw material resin or the like, loss of heating time for melting the replaced raw material resin, or the like. Therefore, it is desirable to unify whether the common part of the outer parts of the first multifunction device 11 and the second multifunction device 111 are made of the recycled material or the non-recycled material. From the viewpoint of increasing the recycled material usage rate, it is desirable that the common part of the outer parts of the first multifunction device 11 and the second multifunction device 111 are basically unified to the recycled material.

There are also outer parts that are not the common part between the first multifunction device 11 and the second multifunction device 111. Therefore, the second multifunction device 111 has an appearance in which the outer part made of the recycled material and the outer part made of the non-recycled material are mixed. In this case, the difference in color tone between the recycled material and the non-recycled material may impair the appearance quality of the second multifunction device 111. Therefore, in the present embodiment, the outer parts are separated for the first outer part 101 that is used in common with the first multifunction device 11 and the third outer part 103 that is not used in common, based on the examination result of examining whether there is a problem such as a difference in color tone in an appearance of the second multifunction device 111. That is, in the second multifunction device 111, the outer part made of the recycled material and the outer part made of the non-recycled material are selected so as not to impair the appearance quality and the like.

As illustrated in FIGS. 10 to 14, the second multifunction device 111 includes the third outer part 103 instead of the second outer part 102 of the first multifunction device 11. The third outer part 103 does not contain the recycled resin material. That is, the third outer part 103 is made of the non-recycled material (general material). The second outer part 102 made of the recycled material included in the first multifunction device 11 is replaced with the third outer part 103 made of the non-recycled material in the second multifunction device 111.

Therefore, the outer section 120 of the second multifunction device 111 includes the first outer part 101, which is the common part, and the third outer part 103. Here, the second outer part 102 is an outer part that constitutes a part of an appearance of the first region A1 of the first multifunction device 11. The second outer part 102 contains the recycled resin material, but the third outer part 103 does not contain the recycled resin material. The third outer part 103 is a part made of the non-recycled material that replaces the second outer part 102 made of the recycled material.

### Use of Outer Part Made of Recycled Material

Next, the outer part of the second multifunction device 111 will be described with reference to FIGS. 10 to 14. In the first multifunction device 11, both the first outer part 101 and the second outer part 102 are made of the recycled material. The first outer part 101 is used to the second multifunction device 111 as the common part, and the second outer part 102 is not used to the second multifunction device 111.

### Outer Part of Second Multifunction Device 111

In the second multifunction device 111, the first outer part 101 made of the recycled material, which is the common part, and the third outer part 103 made of the non-recycled material, which is not the common part, are mixed. In the second multifunction device 111, the second outer part 102 made of the recycled material in the first multifunction device 11 is replaced with the third outer part 103 made of the non-recycled material. By selecting the first outer part 101 and third outer part 103, even if the first outer part 101 made of the recycled material and the third outer part 103 made of the non-recycled material are mixed in a region of the second multifunction device 111 corresponding to the first region A1 of the first multifunction device 11, an aesthetic appearance of the second device 110 is less likely to be impaired. Therefore, the second multifunction device 111 has the following features regarding the selection and layout of the first outer part 101 and the third outer part 103.

### Outer Configuration in Which Recycled Material and Non-Recycled Material are Separated Vertically

In the second multifunction device 111, the first outer part 101 and the third outer part 103 are positioned at different positions in the vertical direction Z. For example, in the front surface 20A illustrated in FIG. 10, the main body cover 62 that is the first outer part 101 and the printing material cover 61 that is the third outer part 103 are positioned at different positions in the vertical direction Z. That is, the main body cover 62 made of the recycled material and the printing material cover 61 made of the non-recycled material are separated vertically. In particular, the printing material cover 61 positioned on an upper side closer to the second region A20 with respect to the main body cover 62 belonging to the first region A10 is made of the non-recycled material, and thus the front surface 20A is mainly separated for a region made of the recycled material and a region made of the non-recycled material vertically.

For example, in the right side surface 20B illustrated in FIG. 11, the feed tray 39 and the first maintenance cover 65, which are the first outer parts 101, and the lower maintenance cover 67, which is the third outer part 103, are positioned at different positions in the vertical direction Z. That is, in the right side surface 20B, the feed tray 39 and the first maintenance cover 65 made of the recycled material and the maintenance cover 67 made of the non-recycled material are separated vertically. Further, in the right side surface 20B, the upper panels 68A and 69A, which are the first outer parts 101, and the lower panels 68B and 69B, which are the third outer parts 103, are positioned at different positions in the vertical direction Z. That is, in the right side surface 20B, the upper panels 68A and 69A made of the recycled material and the lower panels 68B and 69B made of the non-recycled material are separated vertically. In the right side surface 20B, the housing 80A of the interface device 80 positioned adjacent to the lower panel 69B is made of the non-recycled material. By adopting such an outer structure, the right side surface 20B is mainly separated for a region made of the recycled material and a region made of the non-recycled material vertically.

For example, in the left side surface 20C illustrated in FIG. 12, the upper panel 85 and the rear panel 86, which are the first outer parts 101, and the lower panel 87, which is the third outer part 103, are positioned at different positions in the vertical direction Z. That is, in the left side surface 20C, the upper panel 85 and the rear panel 86 made of the recycled material and the lower panel 87 made of the non-recycled material are separated vertically. Further, at a right end section of the left side surface 20C, the main body cover 62 and the upper side edge section 63, which are the first outer parts 101, and the lower side edge section 64, which is the third outer part 103, are positioned at different positions in the vertical direction Z. That is, in the left side surface 20C, the main body cover 62 and the upper side edge section 63 made of the recycled material and the lower side edge section 64 made of the non-recycled material are separated vertically. Here, the lower panel 87, which is made of the non-recycled material, and the lower side edge section 64, which is also made of the non-recycled material, are arranged at substantially the same height position in the vertical direction Z, and have substantially the same length dimension in the vertical direction Z. Therefore, the left side surface 20C is mainly separated for a region made of the recycled material and a region made of the non-recycled material vertically in a region excluding the discharge tray 83 and the maintenance cover 84.

Further, for example, in the rear surface 20D illustrated in FIG. 13, the rear panel 86 and the panel 88 on an upper side, which are the first outer parts 101, and the panels 90 and 91 on a lower side, which are the third outer parts 103, are positioned at different positions in the vertical direction Z. That is, in the rear surface 20D, the upper panels 86 and 88 made of the recycled material and the lower panels 90 and 91 made of the non-recycled material are separated vertically. By adopting the outer structure described above, when the first outer part 101 of the first multifunction device 11 is used to the second multifunction device 111, an aesthetic appearance of the second multifunction device 111 is less likely to be impaired.

### Outer Configuration in Which Recycled Material and Non-Recycled Material are Separated in Left-Right Direction

In the second multifunction device 111, the first outer part 101 and the third outer part 103 are positioned at different positions in a direction intersecting the vertical direction Z. The first outer part 101 made of the recycled material and the third outer part 103 made of the non-recycled material are positioned at different positions in at least one of the depth direction X and the width direction Y, which are directions intersecting the vertical direction Z.

For example, in the front surface 20A illustrated in FIG. 10, the front wall section 38B of the cassette 38, which is the first outer part 101, and the side edge section 64, which is the third outer part 103, are positioned at different positions in the width direction Y. That is, in the front surface 20A, the front wall section 38B of the cassette 38, which is made of the recycled material, and the side edge section 64, which is made of the non-recycled material, are separated in a left-right direction.

For example, in the right side surface 20B illustrated in FIG. 11, a right side section of the cassette 38, which is the first outer part 101, and the lower maintenance cover 67, which is the third outer part 103, are positioned at different positions in the depth direction X. That is, in the right side surface 20B, the right side section of the cassette 38, which is made of the recycled material, and the maintenance cover 67, which is made of the non-recycled material, are separated in the left-right direction.

Further, for example, in the left side surface 20C illustrated in FIG. 12, the panels 85 and 86, which are the first outer parts 101, and the discharge tray 83 and the maintenance cover 84, which are the third outer parts 103, are positioned at different positions in the depth direction X. That is, in the left side surface 20C, the panels 85 and 86, which are made of the recycled material, and the discharge tray 83 and the maintenance cover 84, which are made of the non-recycled material, are separated in the left-right direction.

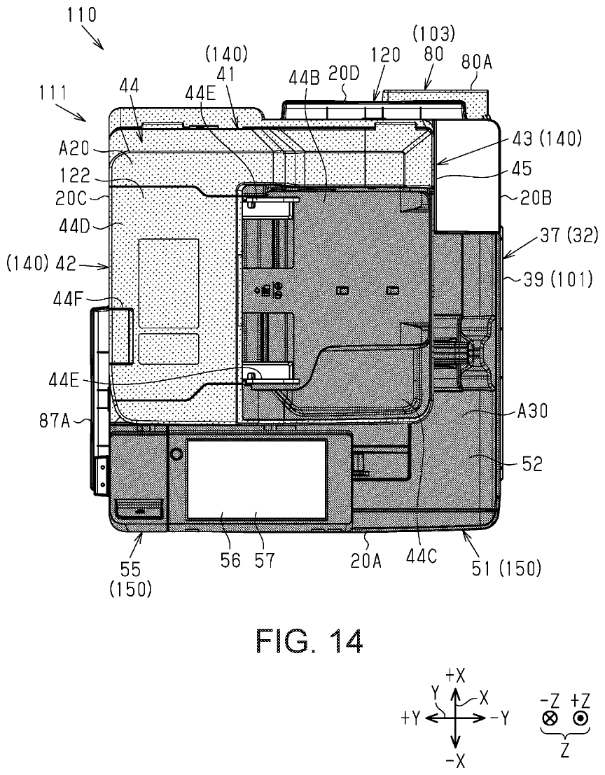

As illustrated in FIG. 14, in an upper surface of the second multifunction device 111, the second outer section 122 having the second region A20 as an appearance and made of the non-recycled material is positioned on a left back side (upper left in FIG. 14), and the third outer section 123 having the third region A30 as an appearance and made of, for example, the recycled material is positioned on a right front side (lower right in FIG. 14). In top view, the document tray 44B and the third outer section 123, both of which exhibit the second color, partially overlap each other. In top view, the region is separated for the second region A20 that exhibits the first color on an upper left side and a region that exhibits the second color on a lower right side. Since a region made of the recycled material is quite small on the upper surface of the second multifunction device 111, the adjacent portion between the region made of the recycled material and the region made of the non-recycled material is quite small.

### Outer Configuration in Which Non-Recycled Material is Arranged at Corner Section

In the second multifunction device 111, the third outer part 103 is positioned at a corner section. For example, in the front surface 20A illustrated in FIG. 10 and the left side surface 20C illustrated in FIG. 12, the side edge section 64, which is the third outer part 103, is positioned at the corner section. The printing device 31 has a substantially rectangular parallelepiped shape. The side edge section 64 made of the non-recycled material is positioned at a left corner section of the printing device 31 in the front surface 20A illustrated in FIG. 10. A left surface of the side edge section 64 appears on the left side surface 20C of the second multifunction device 111 (see FIG. 12). In the left side surface 20C illustrated in FIG. 12, the side edge section 64 appears at a right corner section. On the left side surface 20C, the panel 87 made of the non-recycled material is arranged horizontally adjacent (to the left of) the side edge section 64. Therefore, a region where the non-recycled material is continuous is formed in a lower section of the left side surface 20C. The side edge section 64 is a relatively small outer part. Therefore, even if the side edge section 64 is arranged adjacent to the recycled material at the front surface 20A, the difference in color tone is not easily noticeable, and even if the side edge section 64 is not made of the recycled material, the recycled material usage rate of the second multifunction device 111 is not affected so much. As illustrated in FIG. 12, the pocket 87A assembled to the panel 87 may be made of the recycled material.

For example, in the right side surface 20B illustrated in FIG. 11, the panel 69B that is the third outer part 103 is positioned at a corner section. The panel 69B made of the non-recycled material is positioned at a left corner section of the printing device 31 in the right side surface 20B illustrated in FIG. 11. A left surface of the lower panel 69B functions as a restriction surface that restricts closed positions of the second to fourth cassettes 38. A left surface of the upper panel 69A functions as a restriction surface that restricts a closed position of the first cassette 38.

### Area of First Outer Part 101 in Second Device 110

An area of the first outer part 101 is equal to or more than half of an area of a first surface of the second multifunction device 111, which is an example of the second device 110. Here, the first surface may be a partial surface of the first multifunction device 11. The first surface may be one surface of the four surfaces 20A to 20D when the second multifunction device 111 is viewed from four sides in the +X direction, the −X direction, the +Y direction, and the −Y direction. The first surface may be a side perimetral surface that is the entire four surfaces 20A to 20D of the second multifunction device 111. Further, the first surface may be the entire appearance that can be visually recognized by a user in normal use of the second multifunction device 111. That is, the first surface may be all of the four surfaces 20A to 20D and the upper surface of the second device 110.

An area occupied by the first outer part 101 in the first surface of the second multifunction device 111 is desirably 50% or more. An area occupied by the first outer part 101 in the first surface is more desirably 75% or more, and still more desirably 90% or more.

In the second multifunction device 111, the first surface on which an area of the first outer part 101 occupies half or more corresponds to the front surface 20A illustrated in FIG. 10, the right side surface 20B illustrated in FIG. 11, and the rear surface 20D illustrated in FIG. 13. As illustrated in FIG. 10, an area of the first outer part 101 occupies more than half (50% or more) of an area of the front surface 20A of the second multifunction device 111. In particular, the area of the first outer part 101 occupies more than 65% of the area of the front surface 20A. Here, since the second color is the dark color (for example, black) having a lower brightness than the first color, it is not necessary to perform color matching again even when the non-recycled material is changed to the recycled material. When the outer part exhibiting the second color is made of the recycled material, an area occupied by the recycled material is 75% or more of the area of the front surface 20A.

As illustrated in FIG. 11, an area of the first outer part 101 occupies more than half (50% or more) of an area of the right side surface 20B of the second multifunction device 111. When the member exhibiting the second color is made of the recycled material, an area occupied by the recycled material is 60% or more of the area of the right side surface 20B.

As illustrated in FIG. 13, an area of the first outer part 101 occupies more than half (50% or more) of an area of the rear surface 20D of the second multifunction device 111. Even if the member exhibiting the second color is made of the recycled material, an area of the member exhibiting the second color is small in the rear surface 20D, and thus an area occupied by the first outer part 101 in the first surface is 50% or more. As illustrated in FIG. 12, an area of the first outer part 101 occupies more than 40% or more of an area of the left side surface 20C of the second multifunction device 111.

In a case where the first surface is the side perimetral surface that is the entire four surfaces 20A to 20D of the second multifunction device 111, an area of the first outer part 101 is half or more (50% or more) in the first surface (side perimetral surface) of the second multifunction device 111. Further, when the first surface is the four surfaces 20A to 20D and the upper surface which are the entire appearance that can be visually recognized in normal use of the second multifunction device 111, an area of the first outer part 101 is half or more (50% or more) in the first surface (appearance total area) of the second multifunction device 111.

### Other Configuration of Second Multifunction Device 111

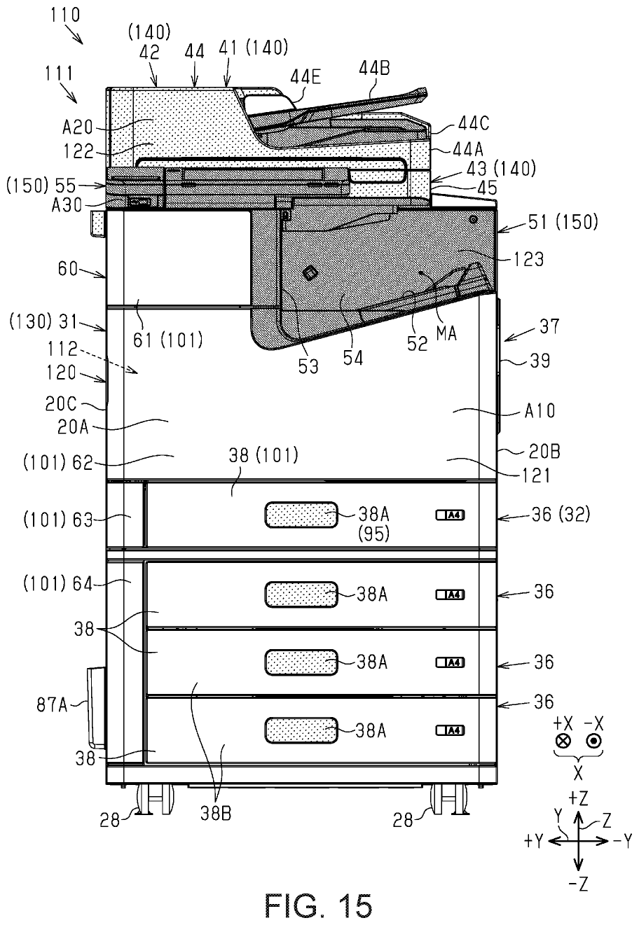

Next, another configuration related to the first surface of the second multifunction device 111, which is an example of the second device 110, will be described with reference to FIG. 15. As illustrated in FIG. 15, the front surface 20A, which is an example of the first surface of the second multifunction device 111, may be formed by the first outer part 101. In the second multifunction device 111 illustrated in FIG. 10, both the printing material cover 61 and the side edge section 64 are made of the non-recycled material. In an example illustrated in FIG. 15, in the second multifunction device 111, both the printing material cover 61 and the side edge section 64 are made of the recycled material. That is, both the printing material cover 61 and the side edge section 64 may be configured as the first outer part 101.

As illustrated in FIG. 15, the device main body 112 may include the resin part 95 related to transport of the medium M1. The resin part 95 may be, for example, the accommodation section 93 partially exposed to the back of the handle section 38A of the cassette 38. In the second multifunction device 111, only the handle section 38A of the cassette 38 may be made of the non-recycled material. The handle section 38A may also be made of the recycled material.

### Characteristic Configuration of Second Multifunction Device 111

The second multifunction device 111, which is an example of the second device 110, may include any one of the following five characteristic configurations.
(a) The first outer part 101 and the third outer part 103 are positioned at different positions in the vertical direction Z.
(b) The first outer part 101 and the third outer part 103 are positioned at different positions in a direction intersecting the vertical direction Z.
(c) The third outer part 103 is positioned at a corner section.
(d) The front surface 20A is formed by the first outer part 101.
(e) An area of the first outer part 101 is equal to or more than half of an area of the first surface.

The characteristic configuration shown in the above-described (a) corresponds to the front surface 20A, the right side surface 20B, the left side surface 20C, and the rear surface 20D illustrated in FIGS. 10 to 13. The characteristic configuration shown in the above-described (b) corresponds to the front surface 20A illustrated in FIG. 10 and the left side surface 20C illustrated in FIG. 12. The characteristic configuration shown in the above-described (c) corresponds to the front surface 20A illustrated in FIG. 10 and the left side surface 20C illustrated in FIG. 12. The side edge section 64 corresponds to the third outer section 23 arranged at the corner section of the second multifunction device 111. The characteristic configuration shown in the above-described (d) corresponds to the front surface 20A illustrated in FIG. 15. The front surface 20A is formed by the first outer part 101. As illustrated in FIG. 15, for example, substantially the entire front surface 20A of the printing device 31, which is the first processing device 130, may be unified with the recycled material. The characteristic configuration shown in the above-described (e) corresponds to the front surface 20A illustrated in FIG. 10, the right side surface 20B illustrated in FIG. 11, the rear surface 20D illustrated in FIG. 13, and the front surface 20A illustrated in FIG. 15. In the configuration of (d), the front surface 20A of the second multifunction device 111 may be formed by the third outer part 103 instead of the second outer part 102. For example, the entire front surface 20A of the printing device 31 may be made of the non-recycled material to prevent the impairment of the appearance quality.

### Operations of Embodiment

First, operations of the first multifunction device 11 will be described. The third outer section 23, which is the outer section of the third processing device 50 positioned between the printing device 31 including the first outer section 21 made of the recycled material and the first image reading device 42 (ADF device 44) including the second outer section 22 made of the non-recycled material (general material), has the second color having a lower brightness than the first color that is the color of the first outer section 21 of the printing device 31 and the second outer section 22 of the ADF device 44. The first color is, for example, white. The second color is the dark color, for example, black.

The first outer section 21 made of the recycled material may be slightly yellowish in a dark place as compared with the second outer section 22 made of the non-recycled material. The first outer section 21 and the second outer section 22 are the same white color but have slightly different colors. However, the third outer section 23 of the third processing device 50 positioned between the printing device 31 and the ADF device 44 has the second color (for example, black) having a lower brightness than the first color. Therefore, the difference in color between the first outer section 21 of the printing device 31 and the second outer section 22 of the ADF device 44 is less likely to be noticeable. Therefore, even if the ratio of the outer part made of the recycled material in the outer section 20 is increased, the difference in color is less likely to be noticeable. Therefore, the recycled material usage rate of the outer section 20 can be increased without impairing an appearance of the multifunction device 11.

In particular, in the present embodiment, the color of the outer section of each of all (three) processing devices constituting the third processing device 50 positioned between the first processing device 30 and the second processing device 40 has the second color (for example, black). That is, the color of the outer section of each of the stacking device 51, the operation device 55, and the image reading device 43 constituting the third processing device 50 has the second color (for example, black). Therefore, it is possible to increase the recycled material usage rate of the outer part constituting the outer section 20 while preventing the impairment of an appearance due to the difference in color of the outer section 20 of the multifunction device 11.

### Operations of Second Multifunction Device 111

Next, operations of the second multifunction device 111 will be described. The common part with the first multifunction device 11 among the outer parts of the second multifunction device 111 is made of the recycled material. The front surface 20A of the printing device 31 is a surface that is frequently visually recognized by a user. The front surface 20A of the second device 110 is mainly constituted by the first outer part 101 made of the recycled material. Therefore, in the front surface 20A, there are few boundaries between the recycled material and the non-recycled material. Therefore, even if there is the difference in color tone between the recycled material and the non-recycled material, it is not noticeable.

In the second multifunction device 111, the first outer part 101 and the third outer part 103 are positioned at different positions in the vertical direction Z. In the front surface 20A, the main body cover 62 made of the recycled material and the printing material cover 61 made of the non-recycled material are separated vertically. The printing material cover 61 made of the non-recycled material is positioned closer to the second region A20 than the main body cover 62 made of the recycled material. Therefore, the region made of the non-recycled material including the second region A20 and the printing material cover 61 and the first region A10 made of the recycled material are separated vertically.

The region made of the recycled material and the region made of the non-recycled material are separated vertically in the right side surface 20B, the left side surface 20C, and the rear surface 20D of the second multifunction device 111. Therefore, each of the surfaces 20A, 20C, and 20D of the second multifunction device 111 is separated for an upper region made of the recycled material and a lower region made of the non-recycled material in the vertical direction Z. The lower region made of the non-recycled material is formed in a band shape extending in a lateral direction over the three surfaces 20B to 20D. Even if the first outer part 101 made of the recycled material and the third outer part 103 made of the non-recycled material have different color tones, the appearance quality of the second multifunction device 111 is less likely to be impaired.

### Effects of Embodiment

According to the present embodiment, the following effects are obtained.
(1) The device 10 includes the device main body 12 and the outer section 20. The outer section 20 is attached to an outside of the device main body 12 and constitutes an appearance of the device 10. The outer section 20 includes the first outer section 21 that constitutes an appearance of the continuous first region A1 and the second outer section 22 that constitutes an appearance of the continuous second region A2. The first outer section 21 contains the recycled resin material. The second outer section 22 does not contain the recycled resin material. According to this configuration, when the outer section 20 is desired to be configured by mixing the recycled resin material and the non-recycled resin material, the type of the recycled resin material or the non-recycled resin material is changed for each of the regions A1 and A2 continuous in the first outer section 21 and the second outer section 22. Therefore, even if the first outer section 21 and the second outer section 22 have the same color but the color is different depending on whether the material is the recycled resin material or the non-recycled resin material, it is possible to prevent an aesthetic appearance of the outer section 20 of the device 10 from being impaired due to the difference in color. Therefore, it is possible to increase the recycled material usage rate in the device 10 while preventing an aesthetic appearance of the device 10 from being impaired due to the difference in color.
(2) The device main body 12 includes the first processing device 30 that performs the first process and the second processing device 40 that performs the second process. The first outer section 21 constitutes at least a part of an appearance of the first processing device 30. The second outer section 22 constitutes at least a part of an appearance of the second processing device 40.

According to this configuration, in a case of the device 10 configured as an assembly of the plurality of processing devices 30 and 40, by separating the region for each processing devices 30 and 40, it is possible to prevent deterioration of an aesthetic appearance of the multifunction device 11, which is an example of the device 10.
(3) The first processing device 30 is the printing device 31 that executes printing on a medium as the first process. The second processing device 40 is the image reading device 41 (42) that reads an image of a medium as the second process. According to this configuration, in the multifunction device 11, a portion of the image reading device 41 (42) and a portion of the printing device 31 are separated, and thus it is possible to prevent deterioration of an aesthetic appearance.
(4) The outer section 20 includes the third outer section 23 positioned between the first outer section 21 and the second outer section 22. The first outer section 21 and the second outer section 22 have the first color. The third outer section 23 has the second color different from the first color. According to this configuration, in a case where colors of the first outer section 21 and the second outer section 22 are the same color, when the first region A1 and the second region A2 are adjacent to each other, the difference in color tone is easily visually recognized. By positioning the third outer section 23 exhibiting the second color different from the first color between the first outer section 21 and the second outer section 22, it is possible to make it difficult to visually recognize the difference in color tone between the first outer section 21 and the second outer section 22, and it is possible to prevent deterioration of an aesthetic appearance of the device 10.
(5) The device main body 12 includes the third processing device 50 positioned between the first processing device 30 and the second processing device 40. The third outer section 23 constitutes at least a part of an appearance of the third processing device 50. According to this configuration, in a case of the device 10 configured as an assembly of the plurality of processing devices 30, 40, and 50, by separating the region for each processing devices 30, 40, and 50, it is possible to prevent deterioration of an aesthetic appearance of the multifunction device 11.
(6) The third processing device 50 is the stacking device 51 that stacks the medium M1 as the third process. The second color has a lower brightness than the first color. According to this configuration, by interposing the stacking device 51 between the first processing device 30 and the second processing device 40, it is possible to prevent deterioration of an aesthetic appearance of the multifunction device 11. Since the third outer section 23 that constitutes at least a part of an appearance of the stacking device 51 has a color having a lower brightness, it is possible to improve visibility of the medium M1 formed of a paper sheet or the like that generally exhibits white. The lower the brightness of the second color exhibited by the third outer section 23, the less noticeable the color difference caused by the recycled resin material and the non-recycled resin material, which are resin materials of the first outer section 21 and the second outer section 22 that are positioned on both sides of the third outer section 23 and have the same color. Therefore, it is possible to more effectively prevent deterioration of an aesthetic appearance of the multifunction device 11.
(7) The outer section 20 includes the fourth outer section 24. The first outer section 21 and the second outer section 22 have the first color. The fourth outer section 24 has the third color different from the first color. The fourth outer section 24 does not contain the recycled resin material.

According to this configuration, the fourth outer section 24 having a color different from the first color, which is the color of the first outer section 21 and the second outer section 22, is made of the non-recycled material, and thus it is possible to prevent the color matching cost of the third color required to prevent the difference in color when the fourth outer section 24 is changed to the recycled resin material.
(8) The device main body 12 includes the resin part 95. The resin part 95 does not contain the recycled resin material. According to this configuration, the resin part 95, which may affect a function due to the strength, the expansion rate, or the like, among resin parts constituting the device main body 12, is not made of the recycled resin material. Therefore, it is possible to increase the recycled material rate of the resin material while preventing deterioration of a function of the device 10.
(9) The resin part 95 is a part related to transport of the medium M1. In this configuration, the medium M1 is generally required to be transported with high accuracy. For example, the accuracy of transport of the medium M1 is required to be high enough to prevent multi-feeding, non-feeding, skew, transport timing deviation, and the like of the medium M1. Therefore, by using the non-recycled material as the resin part 95 related to transport, it is possible to increase the recycled material rate of the resin material while preventing deterioration of a function related to transport.
(10) The first outer section 21 includes the first outer part 101 and the second outer part 102. The first outer part 101 is mountable to the second device 110 when the device is the first device 10. The second device 110 includes the third outer part 103 instead of the second outer part 102. The third outer part 103 does not contain the recycled resin material. In the second device 110, the first outer part 101 and the third outer part 103 are positioned at different positions in the vertical direction Z. According to this configuration, when some parts of the first device 10 are used to the second device 110, it is possible to prevent an aesthetic appearance of the second device 110 from being impaired.
(11) The first outer section 21 includes the first outer part 101 and the second outer part 102. The first outer part 101 is mountable to the second device 110 when the device is the first device 10. The second device 110 includes the third outer part 103 instead of the second outer part 102. The third outer part 103 does not contain the recycled resin material. In the second device 110, the first outer part 101 and the third outer part 103 are positioned at different positions in the direction X or Y intersecting the vertical direction Z. According to this configuration, when some parts of the first device 10 are used to the second device 110, it is possible to prevent an aesthetic appearance of the second device 110 from being impaired.
(12) The first outer section 21 includes the first outer part 101 and the second outer part 102. The first outer part 101 is mountable to the second device 110 when the device is the first device 10. The second device 110 includes the third outer part 103 instead of the second outer part 102. The third outer part 103 does not contain the recycled resin material. In the second device 110, the third outer part 103 is positioned at the corner section. According to this configuration, when some outer parts are used to the second device 110, the corner section of the second device 110 having a relatively small area is made of the non-recycled material (general material) while preventing an aesthetic appearance of the second device 110 from being impaired, and thus it is possible to increase the recycled material usage rate of the second device 110.
(13) The first outer section 21 includes the first outer part 101 and the second outer part 102. The first outer part 101 is mountable to the second device 110 when the device is the first device 10. The second device 110 includes the third outer part 103 instead of the second outer part 102. The third outer part 103 does not contain the recycled resin material. The front surface 20A of the second device 110 is formed by the first outer part 101.

According to this configuration, when some parts are used to the second device 110, it is possible to prevent an aesthetic appearance of the front surface 20A of the second device 110 from being impaired.
(14) The first outer section 21 includes the first outer part 101 and the second outer part 102. The first outer part 101 is mountable to the second device 110 when the device is the first device 10. The second device 110 includes the third outer part 103 instead of the second outer part 102. The third outer part 103 does not contain the recycled resin material. An area of the first outer part 101 is equal to or more than half of an area of the first surface of the second device 110. According to this configuration, when some parts are used to the second device 110, it is possible to increase the recycled material usage rate of the second device 110 that is a diversion destination model while preventing an aesthetic appearance of the first surface of the second device 110 from being impaired.
(15) The second device 110 is a device on which the first outer part 101 that constitutes a part of an appearance of the continuous first region A1 of the first device 10 and that contains the recycled resin material can be mounted. The second device 110 includes the device main body 112 and the outer section 120 that is attached to an outside of the device main body 112 and constitutes an appearance of the second device 110. The outer section 120 includes the first outer part 101 and the third outer part 103 that constitutes a part of an appearance of the first region A1 of the first device 10 and that replaces the second outer part 102 containing the recycled resin material. The third outer part 103 does not contain the recycled resin material. The second device 110 satisfies any one of following conditions (a) to (e).
(a) The first outer part 101 and the third outer part 103 are positioned at different positions in the vertical direction Z.
(b) The first outer part 101 and the third outer part 103 are positioned at different positions in a direction intersecting the vertical direction Z.
(c) The third outer part 103 is positioned at the corner section.
(d) The front surface is formed by the first outer part 101.
(e) An area of the first outer part 101 is equal to or more than half of an area of the first surface.

According to this configuration, when some parts are used from the first device 10 to the second device 110, it is possible to increase the recycled material usage rate of the second device 110 that is a diversion destination model while preventing an aesthetic appearance of the second device 110 from being impaired.

### Modifications

The above-described embodiment may be modified as follows. Furthermore, the above-described embodiment and the modifications described below can be implemented in combination with each other as long as there is no technical contradiction. The following modifications can be implemented in combination as appropriate.

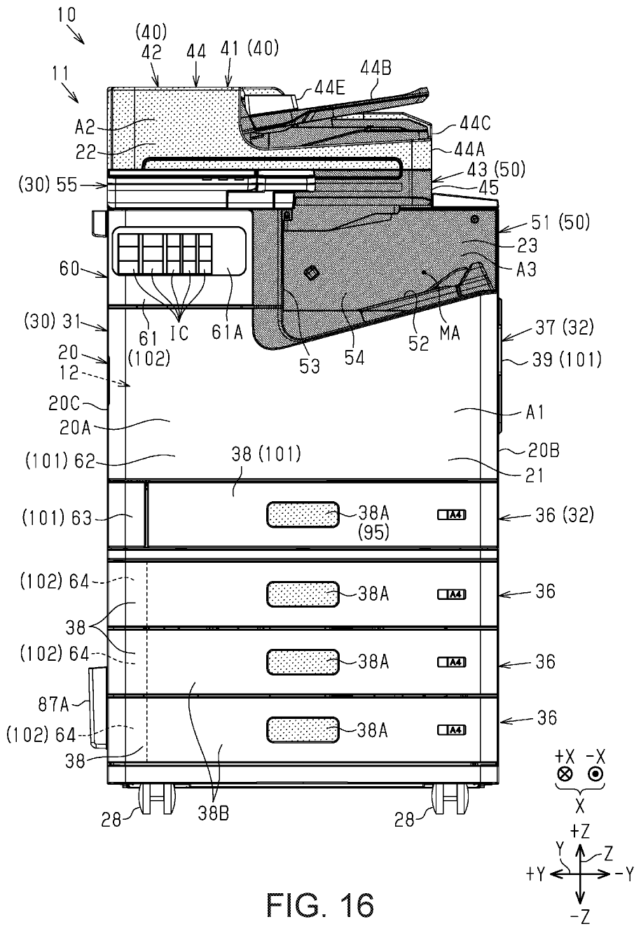

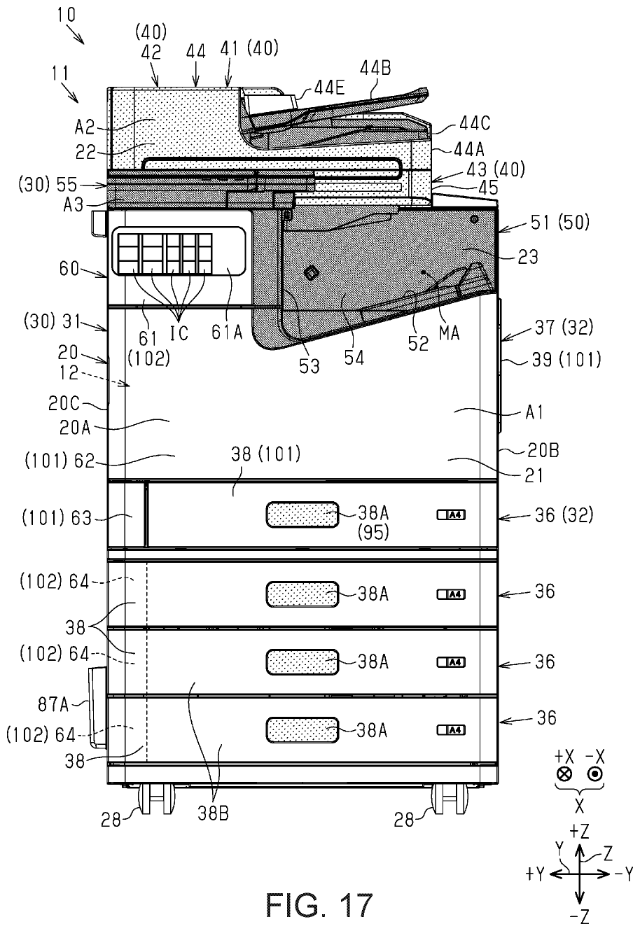

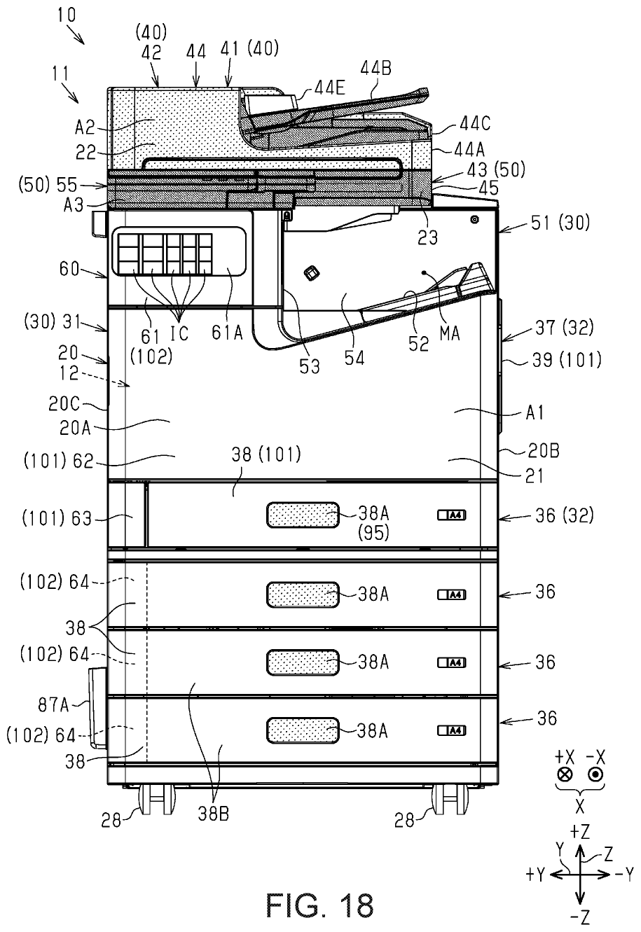

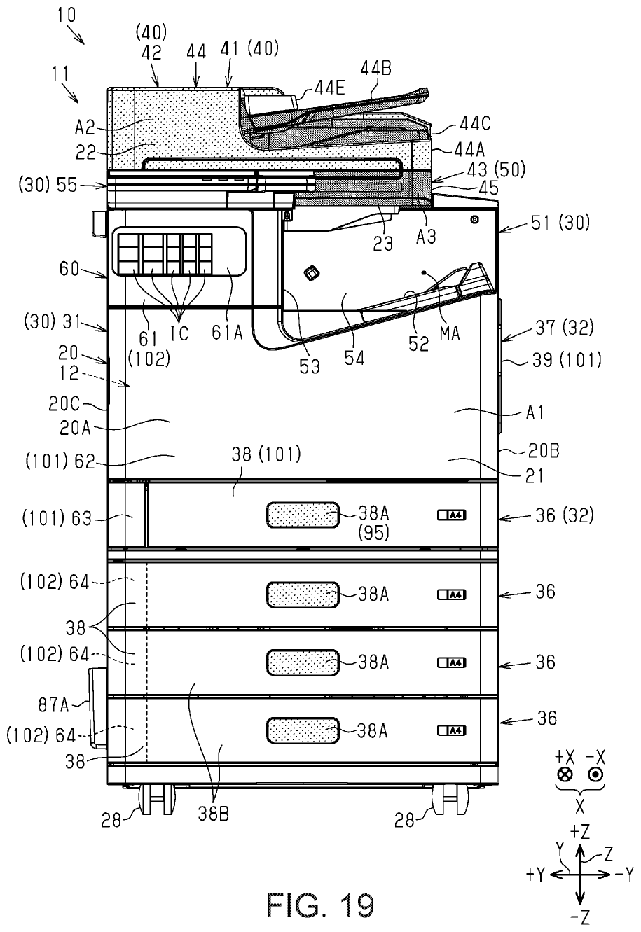

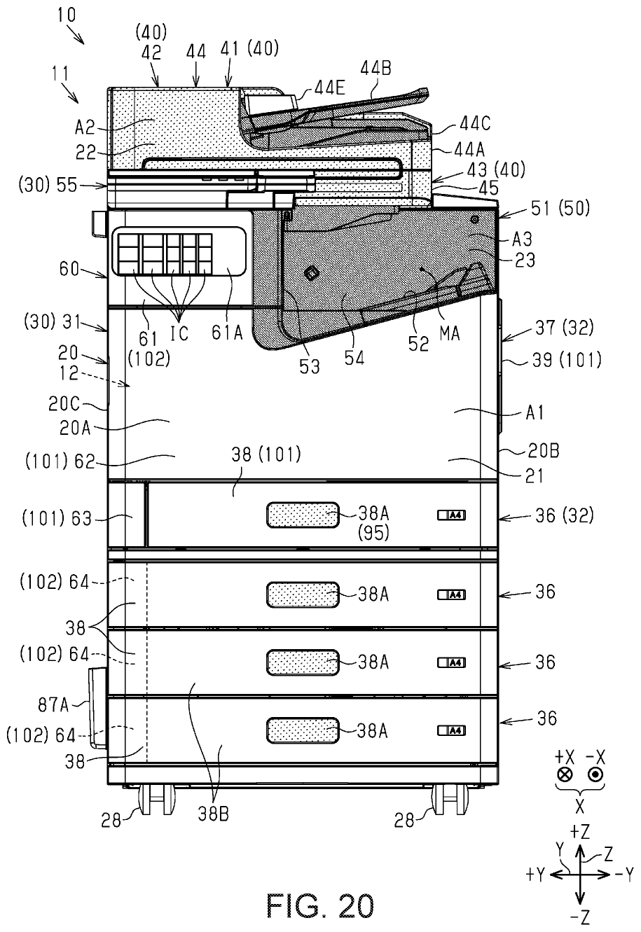

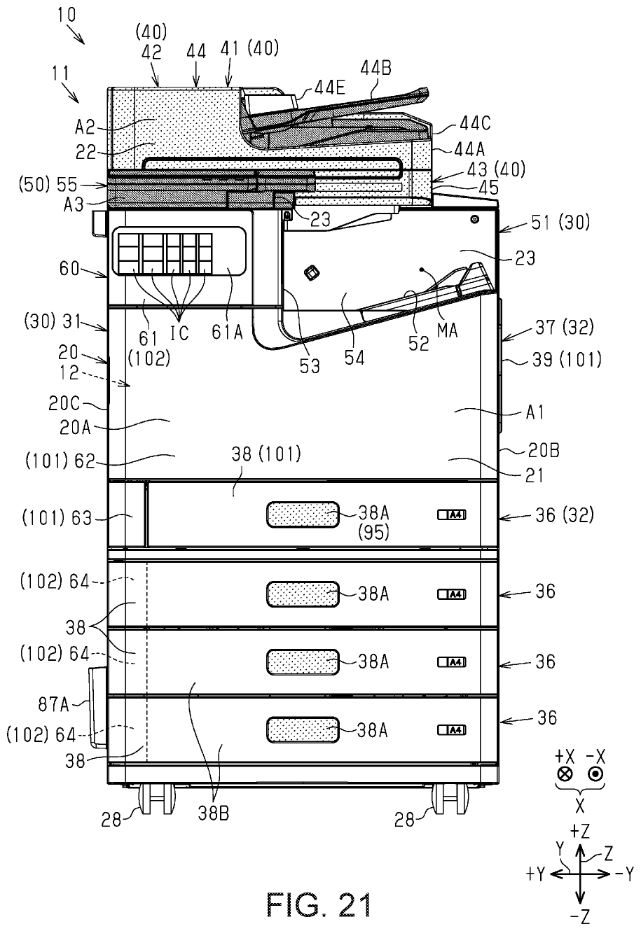

In the above-described embodiment, the third processing device 50 of the device 10 is the second image reading device 43, the stacking device 51, and the operation device 55, but may be at least one of these three devices 43, 51, and 55. For example, as illustrated in FIG. 16, the third processing device 50 may be two devices, that is, the second image reading device 43 and the stacking device 51. In this case, the printing device 31 and the operation device 55 correspond to the first processing device 30. As illustrated in FIG. 17, the third processing device 50 may be two devices, that is, the stacking device 51 and the operation device 55. In this case, the second processing device 40 may be the image reading device 42 (42,43). Further, as illustrated in FIG. 18, the third processing device 50 may be two devices, that is, the second image reading device 43 and the operation device 55. In this case, the printing device 31 and the stacking device 51 correspond to the first processing device 30. As illustrated in FIG. 19, the third processing device 50 may be only the second image reading device 43. In this case, the printing device 31, the stacking device 51, and the operation device 55 correspond to the first processing device 30. The operation device 55 may be configured to belong to the second processing device 40 by being made of the non-recycled material. Further, as illustrated in FIG. 20, the third processing device 50 may be only the stacking device 51. In this case, the printing device 31 and the operation device 55 correspond to the first processing device 30. The operation device 55 may be configured to belong to the second processing device 40 by being made of the non-recycled material. As illustrated in FIG. 21, the third processing device 50 may be only the operation device 55. In this case, the printing device 31 and the stacking device 51 correspond to the first processing device 30.

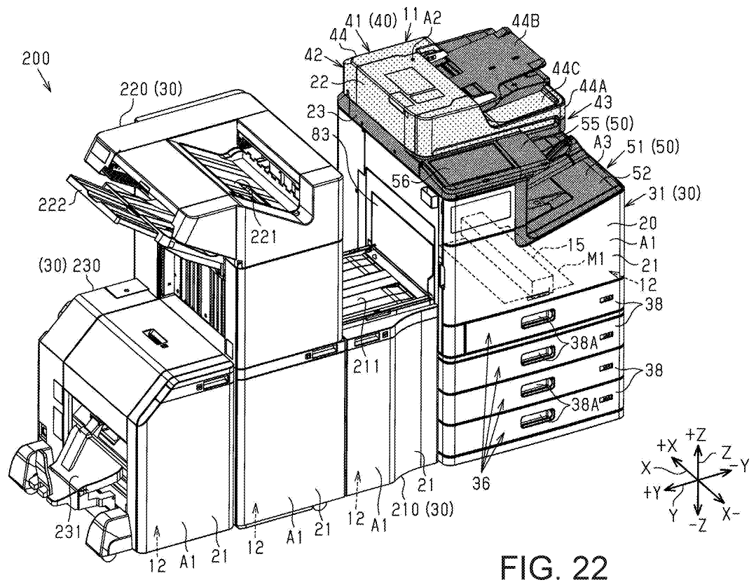

As illustrated in FIG. 22, the device 200 may include the multifunction device 11 and a post-processing device 220 that performs a post-process on the printed medium M1 discharged from the multifunction device 11. The multifunction device 11 is similar to that illustrated in FIG. 3, for example. The device 200 may include an intermediate processing device 210 that performs a process of inverting the medium M1 between the multifunction device 11 and the post-processing device 220. The post-processing device 220 performs, for example, a first post-process including a staple process on the medium M1 as the first process. The device 200 may include a center-folding processing device 230 at a position adjacent to the post-processing device 220 on a downstream side. The center-folding processing device 230 performs, for example, a second post-process including center folding process on the medium M1 as the first process. The post-processing device 220 may include the device main body 12 and the first outer section 21 that constitutes an appearance of the continuous first region A1. The post-processing device 220 may include discharge trays 221 and 222 that discharge the medium M1 or a medium bundle on which the first post-process was performed. The intermediate processing device 210 may include the device main body 12 and the first outer section 21 that constitutes an appearance of the continuous first region A1. The intermediate processing device 210 may include a discharge tray 211 on which the medium M1 is discharged with a printed surface facing upward (face-up) on an upper surface section. The center-folding processing device 230 may include the device main body 12 and the first outer section 21 that constitutes an appearance of the continuous first region A1. The center-folding processing device 230 may include a discharge tray 231 that discharges the medium M1 or a medium bundle on which the second post-process was performed (center-folded).

The device 200 illustrated in FIG. 22 includes the device main body 12 and the outer section 20. The outer section 20 is attached to an outside of the device main body 12 and constitutes an appearance of the device 200. The device main body 12 of the device 200 includes the device main bodies 12 of the multifunction device 11, the intermediate processing device 210, the post-processing device 220, and the center-folding processing device 230. The outer section 20 includes outer sections of the multifunction device 11, the intermediate processing device 210, the post-processing device 220, and the center-folding processing device 230. The outer section 20 includes the first outer section 21 that constitutes an appearance of the continuous first region A1 and the second outer section 22 that constitutes an appearance of the continuous second region A2. The first outer section 21 contains the recycled resin material. The second outer section 22 does not contain the recycled resin material. That is, the first outer section 21 is made of the recycled material, and the second outer section 22 is made of the non-recycled material (general material). In an example illustrated in FIG. 22, the white region of the outer section 20 is the first outer section 21 that constitutes an appearance of the first region A1, and the light dot region is the second outer section 22 that constitutes an appearance of the second region A2. In an example illustrated in FIG. 22, each of the multifunction device 11, the intermediate processing device 210, the post-processing device 220, and the center-folding processing device 230 is the first processing device 30. The image reading device 41 may be the second processing device 40. In particular, the first image reading device 42 of the image reading device may be the second processing device 40. The entire region of an appearance of the first processing device 30 may be the first region A1. In the first processing device 30, a continuous region exceeding half of an appearance may be the first region A1, or a continuous region occupying 80% or more of the appearance may be the first region A1.

The outer section 20 illustrated in FIG. 22 may include the third outer section 23 positioned between the first outer section 21 and the second outer section 22. The device main body may include the third processing device 50 positioned between the first processing device 30 and the second processing device 40. In an example illustrated in FIG. 22, the third outer section 23 and the third processing device 50 are the same as those in FIG. 3. Each of the outer sections of the intermediate processing device 210, the post-processing device 220, and the center-folding processing device 230 may partially include the second outer section 22 made of the non-recycled material. In this case, the first outer section 21 and the second outer section 22 may have the first color, and the third outer section 23 may have the second color. The second color may have a lower brightness than the first color. The first color may be, for example, white, and the second color may be, for example, black. Further, at least one of the discharge trays 211, 221, 222, and 231 of the intermediate processing device 210, the post-processing device 220, and the center-folding processing device 230 may have the second color. When the second color (for example, black) having a lower brightness than the first color is used, the medium M1 such as a white paper sheet or a medium bundle discharged onto the discharge tray is easily visually recognized. At least one of the intermediate processing device 210, the post-processing device 220, and the center-folding processing device 230 may include the resin part 95 that does not contain the recycled resin material. The resin part 95 may be a part related to transport of the medium M1. At least one of the intermediate processing device 210, the post-processing device 220, and the center-folding processing device 230 may include the second outer section 22, or may include the third outer section 23 positioned between the first outer section 21 and the second outer section 22. In the device 200 illustrated in FIG. 22, the multifunction device 11 may be replaced with the multifunction device 11 illustrated in FIGS. 16 to 21, or may be replaced with the second multifunction device 111 illustrated in FIGS. 9 to 14 and 15.

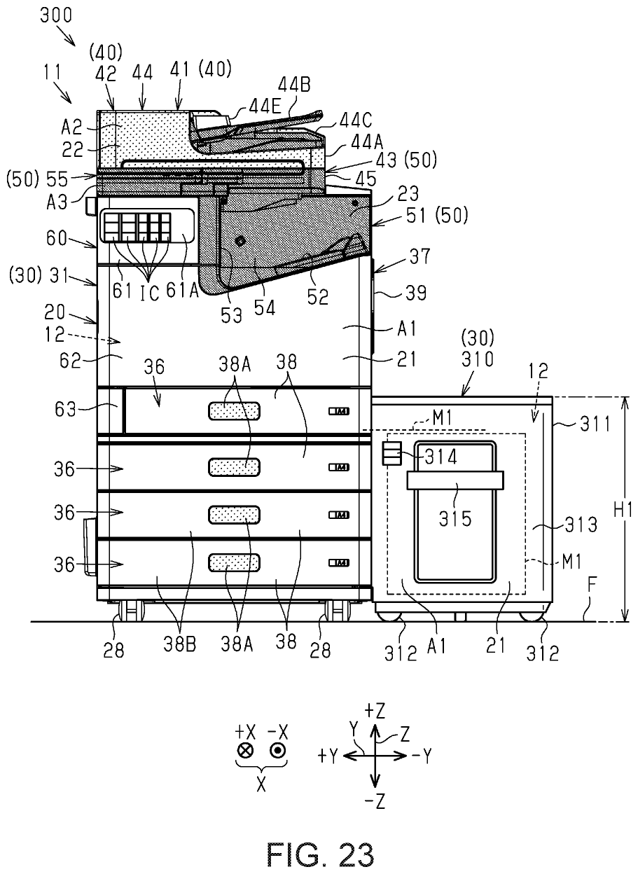

As illustrated in FIG. 23, a device 300 may include the multifunction device 11 and a medium supply device 310 that supplies the medium M1 to the multifunction device 11. The multifunction device 11 is similar to that illustrated in FIG. 3, for example. The medium supply device 310 is a large capacity type that can accommodate a larger number of sheets of a medium than the cassette 38. The medium supply device 310 includes an accommodation main body 311 capable of accommodating a plurality of sheets of the medium M1 in a stacked state, and casters 312. The accommodation main body 311 includes a cover 313 that can be opened and closed, and an opening and closing lever 314. The accommodation main body 311 may include a gripping section 315 that can be gripped when a user opens and closes the cover 313. The cover 313 may be a rotary type in which a medium accommodation section in the accommodation main body 311 is exposed when the cover 313 is opened, or may be a slide type in which a medium accommodation section in the accommodation main body 311 is pulled out to an outside (−X direction) together with the cover 313. A height dimension H1 of the medium supply device 310 from a floor surface F may be substantially the same as a height dimension of the N (for example, four) cassettes 38 of the multifunction device 11. The height dimension H1 is, for example, equal to or greater than a height dimension of (N−1) (for example, three) cassettes 38 from the floor surface F and is lower than a height of a lower end of the feed tray 39. The accommodation main body 311 includes a medium supply port (not illustrated) on a left surface facing the supply port 66A (see FIG. 4) that is open on a right side surface of the multifunction device 11. The medium supply device 310 is connected to the multifunction device 11 so as to be able to deliver the medium M1 from the medium supply port to the supply port 66A of the multifunction device 11. The medium supply device 310 supplies the medium M1 accommodated in a stacked state in the accommodation main body 311 one by one from the uppermost sheet of the medium M1 to the first feed path T1 (see FIG. 2) in the multifunction device 11 through the supply port 66A. The medium supply device 310 may include the device main body 12 and the first outer section 21 that constitutes an appearance of the continuous first region A1.

The device 300 illustrated in FIG. 23 includes the device main body 12 and the outer section 20. The outer section 20 is attached to an outside of the device main body 12 and constitutes an appearance of the device 300. The outer section 20 includes the first outer section 21 that constitutes an appearance of the continuous first region A1 and the second outer section 22 that constitutes an appearance of the continuous second region A2. The first outer section 21 contains the recycled resin material. The second outer section 22 does not contain the recycled resin material. That is, the first outer section 21 is made of the recycled material, and the second outer section 22 is made of the non-recycled material (general material). As illustrated in FIG. 23, the first region A1 of the device 300 includes the first region A1 of the multifunction device 11 and the first region A1 of the medium supply device 310. The first outer section 21 of the device 300 includes the first outer section 21 of the multifunction device 11 and the first outer section 21 of the medium supply device 310. The second outer section 22 of the device 300 is the same as that in FIG. 3, and is an outer section of at least a part of the image reading device 41 (for example, the first image reading device 42). The device 300 may include the third outer section 23 that constitutes an appearance of the continuous third region A3 at a position between the first outer section 21 and the second outer section 22. According to the device 300, the same effects as those of the above-described embodiment can be obtained. Further, in a state where the medium supply device 310 is adjacent to the multifunction device 11, the first outer sections 21 of the two are adjacent to each other, so that a color tone of the first color of both is the same. In the device 300 illustrated in FIG. 23, the multifunction device 11 may be replaced with the second multifunction device 111 illustrated in FIGS. 9 to 14. In the device 300 illustrated in FIG. 23, the multifunction device 11 may be replaced with the multifunction device 11 illustrated in FIGS. 16 to 21, or may be replaced with the second multifunction device 111 illustrated in FIGS. 9 and 15.

The third processing device 50 exhibiting the second color may be the printing material supply device 60. For example, the printing material cover 61 may be the third outer section 23. The printing material cover 61 may have the second color. For example, the image reading device 41 (42, 43) may be the second processing device 40, and the printing material supply device 60 may be one of the third processing devices 50. In this case, the stacking device 51 may be one of the third processing devices 50. The operation device 55 may be one of the second processing devices 40 or one of the third processing devices 50. A device of the printing device 31 excluding the printing material supply device 60 may be the first processing device 30 exhibiting the first color.

The first process and the second process may be the same process. For example, if the process is a medium supply process, there may be a first processing section and a second processing section that perform the same medium supply process but include different medium supply cassettes. When the device 10 includes M medium supply devices 36 that feed the medium M1 from the M cassettes 38 as medium supply devices, j medium supply devices 36 from first to j-th from an upper side may be the first processing devices 30, and (M-j) medium supply devices 36 from (j+1)-th to M-th may be the second processing devices 40. In an example of M=4, among the four medium supply devices 36 including four cassettes 38, the first medium supply device 36 may be the first processing device 30, and the second to fourth three medium supply devices 36 may be the second processing device 40. The first and second medium supply devices 36 may be the first processing devices 30, and the third and fourth medium supply devices 36 may be the second processing devices 40. Further, the first to third medium supply devices 36 may be the first processing devices 30, and the fourth medium supply device 36 may be the second processing device 40. In the three examples described above, the medium supply device 36 constituting the first processing device 30 and the medium supply device 36 constituting the second processing device 40 may be reversed.

The number of the continuous first regions A1 is not limited to one in the outer section 20 of the device 10. The outer section 20 may include a plurality of the continuous first regions A1. That is, the outer section 20 may include a plurality of the first outer sections 21. Note that the continuous first region A1 may be a region extending over a plurality of outer parts or may be a region of only one outer part.

The number of the continuous second regions A2 is not limited to one in the outer section 20 of the device 10. The outer section 20 may include a plurality of the continuous second regions A2. That is, the outer section 20 may include a plurality of the second outer sections 22. Note that one second region A2 may be a region extending over a plurality of outer parts, or may be a region of only one outer part.

The first outer section 21 and the second outer section 22 may be two regions A1 and A2 of one outer part. For example, one outer part may include the first outer section made of the recycled material and the second outer section made of the non-recycled material. One outer part of this type may be manufactured by two-color molding using the recycled resin material and the non-recycled resin material, or may be manufactured by integrally joining the first outer section and the second outer section by welding or adhesive.

The first outer section 21 and the third outer section 23 may be two portions of one outer part. For example, one outer part may include the first outer section containing the recycled resin material and the third outer section containing the recycled resin material or a non-recycled material and exhibiting the third color different from the first color that is a color of the first outer section. The second outer section 22 and the third outer section 23 may be two portions of one outer part. For example, one outer part may include the second outer section made of a resin material (non-recycled resin material) that does not contain the recycled resin material, and the third outer section that contains the recycled resin material or the non-recycled material and that exhibits the third color different from the first color that is a color of the second outer section. One outer part of this type may be manufactured by two-color molding, or may be manufactured by integrally joining two types of outer sections by welding or adhesive. This type of outer part is assembled to the device main body 12 such that the third outer section 23 is positioned between the first outer section 21 and the second outer section 22.

The first color is not limited to white, and may be the light color other than white. The first color may be light gray, light blue, light yellow, pink, light green, light yellow-green, or the like. The first color may have a higher brightness than the second color.

The second color is not limited to black, and may be the dark color other than black. The second color may be dark gray, dark blue, deep red (dark red), or deep green. The second color may have a lower brightness than the first color.

The print head 16 constituting the print processing device 15 is not limited to the liquid ejection head that ejects liquid. The print head 16 may be, for example, a dot impact print head, a thermal print head, or a laser print head that prints with toner.

A color of the first outer section 21 and a color of the second outer section 22 in the device 10 are not limited to both being the first color, and may be different colors from each other. In this case, also in the second device 110, a color of the first outer section 121 and a color of the second outer section 122 are not limited to both being the first color, and may be different colors from each other. For example, a color of the first outer section 21 may be the first color, and a color (for example, a fourth color) of the second outer section 22 may be a color different from the first color and the second color. A color of the second outer section 22 may be different from the first color and may be a color having a higher brightness than the second color.

In the above-described embodiment and modifications, the impairment of the appearance quality due to the difference in color tone is prevented, but the cause of the impairment of the appearance quality is not limited to the difference in color tone. For example, the outer section may be made of the recycled resin material or the non-recycled resin material to prevent the appearance quality of the device from being impaired due to any one of the gloss, surface roughness, and light reflection characteristics of the outer section. Further, the present disclosure is not limited to a case where the appearance quality is impaired, and a user may be less likely to feel the difference in the texture or the like of the outer section due to the difference between the recycled material and the non-recycled material. In these cases, the first outer section 21 and the second outer section 22 may have the same first color or different colors. The third outer section 23 may have a color different from the colors of the first outer section 21 and the second outer section 22, or may have the same color as one of the color of the first outer section 21 and the color of the second outer section 22. The color of the third outer section 23 may have a higher brightness than at least one of the color of the first outer section 21 and the color of the second outer section 22 (for example, a color including the first color). In a case where any one of the gloss, the surface roughness, and the light reflection characteristics of the outer section is different between the first outer section 21 and the second outer section 22, an outer section in which any one of the gloss, the surface roughness, and the light reflection characteristics of the outer section is intermediate between those of the first outer section 21 and the second outer section 22 may be provided as the third outer section 23. The above description may be similarly applied to the first outer section 121, the second outer section 122, and the third outer section 123 in the second device 110.

The third outer section 23 is arranged between the first outer section 21 and the second outer section 22 positioned above and below the third outer section 23, but may be arranged between the first outer section 21 and the second outer section 22 positioned on left and right sides of the third outer section 23. The third outer section 23 may be interposed in the entire region between the first outer section 21 and the second outer section 22, or may be interposed in only a part of the entire region.

The third outer section 23 is not limited to an outer part of the third processing device 50, and may be configured by a panel or a cover.

The third outer section 23 may be omitted, and the first outer section 21 and the second outer section 22 may be adjacent to each other. Since the recycled material and the non-recycled material are applied to each of the continuous regions A1 and A2, it is possible to prevent the impairment of the appearance quality due to the difference in color tone between the two. In particular, if the first region A1 and the second region A2 are set for each of one or more processing devices or for each of one or more outer parts such as covers or panels, it is possible to more effectively prevent the appearance quality from being impaired.

In the above-described embodiment, the image reading device 41 includes the first image reading device 42 and the second image reading device 43, but may include only one of the first image reading device 42 and the second image reading device 43. The image reading device 41 may be only the first image reading device 42 or only the second image reading device 43. In the former case, the second processing device 40 may be the first image reading device 42. In the latter case, the second processing device 40 may be the second image reading device 43.

In the embodiment, the first processing device 30 is the printing device 31, and the second processing device 40 is the first image reading device 42 (ADF device 44). The first processing device or the second processing device is not limited thereto, and may be a processing device that performs another process in the device. The other processing device may be, for example, the first medium supply device 36, an external medium supply device, a transport device, or a post-processing device. The first medium supply device 36 may be an additional cassette unit, a unit of the entire cassette, a large capacity sheet feeding unit, or the like. A portion of the transport device that is inside the device main body 12 is not visually recognized as an appearance, but is visually recognized when a user clears a jam at the time of occurrence of the jam. For example, a portion of the transport mechanism that is exposed when a maintenance cover is opened to clear a jam is an example of the transport device. The post-processing device may be an device for the entire finisher, or an device for each application such as saddle stitching or edge stitching.

The opening and closing lever 65A, 66B, and 67A constituting the fourth outer section 24 may be made of the recycled material. In this case, the recycled material may be performed color matching to the third color (for example, gray) or may be a color that does not need performing color matching. The color that does not need performing color matching may be a color (for example, white) that has been used as the color of the outer part made of the recycled material or the dark color (for example, black).

An actuator that defines an ejection type of the print head 16 may be a piezoelectric actuator (a multilayer piezoelectric element and a thin-film piezoelectric element), a thermal actuator using an electrothermal conversion element such as a heat-generating resistor, an electrostatic actuator including a diaphragm and a counter electrode, or the like.

The medium M1 is not limited to a paper sheet such as roll paper or cut paper, and may be a envelope, board paper, a label, or the like. The medium M1 is not limited to paper, and may be fabric, synthetic resin film, laminated medium, foil, garment, and the like.

The printing device 31 is not limited to a line printer or a serial printer, and may be a lateral printer.

The image reading device 41 may not include the sheet feed type first image reading device 42. The image reading device 41 may not include the flatbed type second image reading device 43.

The device 10 (first device 10) is not limited to the multifunction device 11, and may be a printing device that does not include an image reading device. The device 10 may be an image reading device. The device 10 may be another medium processing device that performs processing on a medium.

The device is not limited to a medium processing device that performs processing on a medium. The device may be a processing device that performs processing on a processing target other than a medium. For example, the device may be an acoustic device such as an audio system, a cooking device such as a microwave oven for cooking using food material, or a home appliance device such as a refrigerator or a washing machine. The device may be a display device such as a television device or a display device including an organic EL display panel, a liquid crystal display panel, or the like.

### Definitions

As used herein, the phrase “at least one” means “one or more” of the desired alternatives. As an example, the phrase “at least one” as used herein means “only one option” or “both of two options” if the number of options is two. As another example, the phrase “at least any” as used herein means “only one option” or “a combination of any two or more options” if the number of options is three or more.

### Technical ideas

Hereinafter, technical ideas grasped from the above-described embodiment and the modifications will be described together with effects.
(1) A device includes a device main body and an outer section that is attached to an outside of the device main body and that constitutes an appearance of the device, wherein the outer section includes a first outer section that constitutes an appearance of a continuous first region and a second outer section that constitutes an appearance of a continuous second region, the first outer section contains a recycled resin material, and the second outer section does not contain the recycled resin material.

According to this configuration, when the outer section is desired to be configured by mixing the recycled resin material and the non-recycled resin material, the recycled resin material or non-recycled resin material is changed for each continuous region between the first outer section and the second outer section. Therefore, even if there is the difference in appearance such as the difference in color between the first outer section and the second outer section depending on whether the material is the recycled resin material or the non-recycled resin material, it is possible to prevent an aesthetic appearance of the outer section of the device from being impaired. Therefore, it is possible to increase the usage rate of the recycled resin material in the device while preventing an aesthetic appearance of the device from being impaired.
(2) The device according to (1) may be configured such that the device main body includes a first processing device that performs a first process and a second processing device that performs a second process, the first outer section constitutes at least a part of an appearance of the first processing device, and the second outer section constitutes at least a part of an appearance of the second processing device.

According to this configuration, when the device is formed by an assembly of a plurality of processing devices, the region is separated for each device, and thus it is possible to prevent deterioration of an aesthetic appearance.
(3) The device according to (1) or (2) may be configured such that the first processing device is a printing device that executes printing on a medium as the first process and the second processing device is an image reading device that reads an image on a medium as the second process.

According to this configuration, in the multifunction device, the recycled material and the non-recycled material are separated in a portion of the printing device and a portion of the image reading device, and thus it is possible to prevent deterioration of an aesthetic appearance.
(4) The device according to any one of (1) to (3) may be configured such that the outer section includes a third outer section positioned between the first outer section and the second outer section, the first outer section and the second outer section have a first color, and the third outer section has a second color different from the first color.

According to this configuration, in a case where the first outer section and the second outer section have the same color, the difference in color tone is easily visually recognized when the first region and the second region are adjacent to each other. By positioning the third outer section exhibiting the second color different from the first color between the first outer section and the second outer section, it is possible to make it difficult to visually recognize the difference in color tone, and it is possible to prevent deterioration of an aesthetic appearance of the device.
(5) The device according to any one of (1) to (4) may be configured such that the device main body includes a third processing device positioned between the first processing device and the second processing device and the third outer section constitutes at least a part of an appearance of the third processing device.

According to this configuration, in a case of a device configured as an assembly of a plurality of processing devices, it is possible to prevent deterioration of an aesthetic appearance by separating the region for each device.
(6) The device according to any one of (1) to (5) may be configured such that the third processing device is a stacking device that stacks a medium as a third process and the second color has a lower brightness than the first color.

According to this configuration, the stacking device is interposed between the first processing device and the second processing device, and thus it is possible to prevent deterioration of an aesthetic appearance of the device. Since the third outer section constituting at least a part of an appearance of the stacking device has a color with low brightness, the visibility of the medium that generally exhibits white is improved. As the second color exhibited by the third outer section is a color having a lower brightness, it is possible to make a color difference caused by the recycled resin material and the non-recycled resin material, which are the resin materials of the first outer section and the second outer section that are positioned on both sides of the third outer section and have the same color, less noticeable. Therefore, it is possible to more effectively prevent deterioration of an aesthetic appearance of the device.
(7) The device according to any one of (1) to (6) may be configured such that the outer section includes a fourth outer section, the first outer section and the second outer section have a first color, the fourth outer section has a third color different from the first color, and the fourth outer section does not contain the recycled resin material.

According to this configuration, the fourth outer section having a color different from the first color, which is the color of the first outer section and the second outer section, is made of the non-recycled resin material, and thus it is possible to prevent the color matching cost of the third color required to prevent the difference in color when the fourth outer section is changed to the recycled resin material.
(8) The device according to any one of (1) to (7) may be configured such that the device main body includes a resin part and the resin part does not contain the recycled resin material.

According to this configuration, the resin part, which may affect a function due to the strength, the expansion rate, or the like, among resin parts constituting the device main body, is not made of the recycled resin material. Therefore, the recycled material rate of the resin material can be increased while preventing deterioration of the function of the device.
(9) The device according to (8) may be configured such that the resin part is a part related to transport of a medium.

According to this configuration, in general, accuracy (suppression of multi-feeding, non-feeding, skew, transport timing deviation, and the like) is required for transport of the medium. Therefore, by using the non-recycled material as a resin part related to transport, it is possible to increase the recycled material rate of the resin material while more effectively preventing the function deterioration.
(10) The device according to any one of (1) to (9) may be configured such that the first outer section includes a first outer part and a second outer part, the first outer part is configured to be mounted to a second device when the device is a first device, the second device includes a third outer part instead of the second outer part, the third outer part does not contain the recycled resin material, and in the second device, the first outer part and the third outer part are positioned at different positions in a vertical direction.

According to this configuration, when some parts of the first device are used to the second device, it is possible to prevent an aesthetic appearance of the second device from being impaired.
(11) The device according to any one of (1) to (10) may be configured such that the first outer section includes a first outer part and a second outer part, the first outer part is configured to be mounted to a second device when the device is a first device, the second device includes a third outer part instead of the second outer part, the third outer part does not contain the recycled resin material, and in the second device, the first outer part and the third outer part are positioned at different positions in a direction intersecting a vertical direction.

According to this configuration, when some parts of the first device are used to the second device, it is possible to prevent an aesthetic appearance of the second device from being impaired.
(12) The device according to any one of (1) to (11) may be configured such that the first outer section includes a first outer part and a second outer part, the first outer part is configured to be mounted to a second device when the device is a first device, the second device includes a third outer part instead of the second outer part, the third outer part does not contain the recycled resin material, and in the second device, the third outer part is positioned at a corner section.

According to this configuration, when some parts are used to the second device, the corner section of the second device having a relatively small area is made of the non-recycled material (general material) while preventing an aesthetic appearance of the second device from being impaired, and thus it is possible to increase the recycled material usage rate of the second device.
(13) The device according to any one of (1) to (12) may be configured such that the first outer section includes a first outer part and a second outer part, the first outer part is configured to be mounted to a second device when the device is a first device, the second device includes a third outer part instead of the second outer part, the third outer part does not contain the recycled resin material, and a front surface of the second device is formed by the first outer part.

According to this configuration, when some parts are used to the second device, it is possible to prevent an aesthetic appearance of the front surface of the second device from being impaired.
(14) The device according to any one of (1) to (13) may be configured such that the first outer section includes a first outer part and a second outer part, the first outer part is configured to be mounted to a second device when the device is a first device, the second device includes a third outer part instead of the second outer part, the third outer part does not contain the recycled resin material, and an area of the first outer part is equal to or more than half of an area of a first surface of the second device.

According to this configuration, when some parts are used to the second device, it is possible to increase the recycled material usage rate of the second device that is a diversion destination model while preventing an aesthetic appearance of the first surface of the second device from being impaired.
(15) A device to which a first outer part that constitutes a part of an appearance of a continuous first region of a first device and that contains a recycled resin material is configured to be mounted, the device includes a device main body and an outer section that is attached to an outside of the device main body and that constitutes an appearance of the device, wherein the outer section includes the first outer part and a third outer part that constitutes a part of an appearance of the first region of the first device and replaces the second outer part containing the recycled resin material, the third outer part does not contain the recycled resin material, any one of following conditions (a) to (e) is satisfied, and the conditions (a) to (e) are (a) the first outer part and the third outer part are positioned at different positions in a vertical direction, (b) the first outer part and the third outer part are positioned at different positions in a direction intersecting the vertical direction, (c) the third outer part is positioned at a corner section, (d) a front surface is formed by the first outer part, and (e) an area of the first outer part is equal to or more than half of an area of a first surface.

According to this configuration, when some parts are used from the first device to the second device, it is possible to increase the recycled material usage rate of the second device that is a diversion destination model while preventing an aesthetic appearance of the second device from being impaired.

What is claimed is:

1. A device comprising:
a device main body and
an outer section that is attached to an outside of the device main body and that constitutes an appearance of the device, wherein
the outer section includes
a first outer section that constitutes an appearance of a continuous first region and
a second outer section that constitutes an appearance of a continuous second region,
the first outer section contains a recycled resin material, and
the second outer section does not contain the recycled resin material.

2. The device according to claim 1, wherein
the device main body includes
a first processing device that performs a first process and
a second processing device that performs a second process,
the first outer section constitutes at least a part of an appearance of the first processing device, and
the second outer section constitutes at least a part of an appearance of the second processing device.

3. The device according to claim 2, wherein
the first processing device is a printing device that executes printing on a medium as the first process and
the second processing device is an image reading device that reads an image on a medium as the second process.

4. The device according to claim 2, wherein
the outer section includes a third outer section positioned between the first outer section and the second outer section,
the first outer section and the second outer section have a first color, and
the third outer section has a second color different from the first color.

5. The device according to claim 4, wherein
the device main body includes a third processing device positioned between the first processing device and the second processing device and
the third outer section constitutes at least a part of an appearance of the third processing device.

6. The device according to claim 5, wherein
the third processing device is a stacking device that stacks a medium as a third process and
the second color has a lower brightness than the first color.

7. The device according to claim 1, wherein
the outer section includes a fourth outer section,
the first outer section and the second outer section have a first color,
the fourth outer section has a third color different from the first color, and
the fourth outer section does not contain the recycled resin material.

8. The device according to claim 1, wherein
the device main body includes a resin part and
the resin part does not contain the recycled resin material.

9. The device according to claim 8, wherein
the resin part is a part related to transport of a medium.

10. The device according to claim 1, wherein
the first outer section includes a first outer part and a second outer part,
the first outer part is configured to be mounted to a second device when the device is a first device,
the second device includes a third outer part instead of the second outer part,
the third outer part does not contain the recycled resin material, and
in the second device, the first outer part and the third outer part are positioned at different positions in a vertical direction.

11. The device according to claim 1, wherein
the first outer section includes a first outer part and a second outer part,
the first outer part is configured to be mounted to a second device when the device is a first device,
the second device includes a third outer part instead of the second outer part,
the third outer part does not contain the recycled resin material, and
in the second device, the first outer part and the third outer part are positioned at different positions in a direction intersecting a vertical direction.

12. The device according to claim 1, wherein
the first outer section includes a first outer part and a second outer part,
the first outer part is configured to be mounted to a second device when the device is a first device,
the second device includes a third outer part instead of the second outer part,
the third outer part does not contain the recycled resin material, and
in the second device, the third outer part is positioned at a corner section.

13. The device according to claim 1, wherein
the first outer section includes a first outer part and a second outer part,
the first outer part is configured to be mounted to a second device when the device is a first device,
the second device includes a third outer part instead of the second outer part,
the third outer part does not contain the recycled resin material, and
a front surface of the second device is formed by the first outer part.

14. The device according to claim 1, wherein
the first outer section includes a first outer part and a second outer part,
the first outer part is configured to be mounted to a second device when the device is a first device,
the second device includes a third outer part instead of the second outer part,
the third outer part does not contain the recycled resin material, and
an area of the first outer part is equal to or more than half of an area of a first surface of the second device.

15. A device to which a first outer part that constitutes a part of an appearance of a continuous first region of a first device and that contains a recycled resin material is configured to be mounted, the device comprising:
a device main body and
an outer section that is attached to an outside of the device main body and that constitutes an appearance of the device, wherein
the outer section includes
the first outer part and
a third outer part that constitutes a part of an appearance of the first region of the first device and replaces the second outer part containing the recycled resin material,
the third outer part does not contain the recycled resin material,
any one of following conditions (a) to (e) is satisfied, and
the conditions (a) to (e) are
(a) the first outer part and the third outer part are positioned at different positions in a vertical direction,
(b) the first outer part and the third outer part are positioned at different positions in a direction intersecting the vertical direction,
(c) the third outer part is positioned at a corner section,
(d) a front surface is formed by the first outer part, and
(e) an area of the first outer part is equal to or more than half of an area of a first surface.
